(19) United States
(12) Patent Application Publication
(10) Pub. No.: US 2023/0156244 A1
(43) Pub. Date: May 18, 2023

(54) INFORMATION PROCESSING APPARATUS, INFORMATION PROCESSING METHOD, AND PROGRAM

(71) Applicant: FUJIFILM Corporation, Tokyo (JP)

(72) Inventors: Takashi AOKI, Saitama-shi (JP); Fuminori IRIE, Saitama-shi (JP); Kazunori TAMURA, Saitama-shi (JP); Masahiko MIYATA, Saitama-shi (JP); Yasunori MURAKAMI, Saitama-shi (JP)

(73) Assignee: FUJIFILM Corporation, Tokyo (JP)

(21) Appl. No.: 18/156,361

(22) Filed: Jan. 18, 2023

Related U.S. Application Data
(63) Continuation of application No. PCT/JP2021/023652, filed on Jun. 22, 2021.

(30) Foreign Application Priority Data
Jul. 31, 2020 (JP) 2020-131167

(51) Int. Cl. H04N 21/218; H04N 21/2668; H04N 21/475

(52) U.S. Cl. CPC H04N 21/21805; H04N 21/2668; H04N 21/4755

(57) ABSTRACT

An information processing apparatus generates an image for viewing to be viewed by a viewer based on an image obtained by imaging with an imaging apparatus. The information processing apparatus acquires request information for requesting generation of the image for viewing, and executes generation processing of generating the image for viewing in accordance with the acquired request information. The request information includes setting information indicating setting of the image for viewing. In the generation processing, the image for viewing to which viewer information related to the viewer of which the setting information is within a predetermined range is reflected in the request information of a plurality of the viewers is generated.

### CROSS-REFERENCE TO RELATED APPLICATIONS

This application is a continuation application of International Application No. PCT/JP2021/023652, filed Jun. 22, 2021, the disclosure of which is incorporated herein by reference in its entirety. Further, this application claims priority under 35 USC 119 from Japanese Patent Application No. 2020-131167 filed Jul. 31, 2020, the disclosure of which is incorporated by reference herein.

### BACKGROUND

### 1. Technical Field

The technology of the present disclosure relates to an information processing apparatus, an information processing method, and a program.

### 2. Related Art

JP2014-215828A discloses an image data playback device that plays back an image from any viewpoint with respect to input content data. The image data playback device disclosed in JP2014-215828A includes a separation unit, a viewpoint decision unit, a viewpoint image generation unit, and an individual viewpoint information generation unit. The separation unit separately outputs, from the content data input from an outside, at least one or more image data and viewpoint information including at least one or more individual viewpoint information indicating from which viewpoint to generate the image by using at least one designated image data out of at least one or more image data. The viewpoint decision unit generates any one of the individual viewpoint information included in the viewpoint information as viewpoint selection information. The viewpoint image generation unit generates and outputs an image of a viewpoint indicated by the viewpoint selection information as a viewpoint image by using the image data designated by the viewpoint selection information out of at least one or more image data. The individual viewpoint information generation unit adds user attribute information, which is information indicating an attribute of a user, to the viewpoint selection information, and generates user attribute addition individual viewpoint information.

JP2020-065301 discloses a terminal used by a user at an imaging place. The terminal disclosed in JP2020-065301A comprises an output unit that outputs viewpoint information to an information processing apparatus that manages a plurality of videos captured from a plurality of viewpoints at the imaging place, an input unit to which a first video selected from among the plurality of videos in accordance with the viewpoint information is input from the information processing apparatus, and a display unit that displays the first video.

JP2019-197340A discloses an information processing apparatus including an acquisition unit, a determination unit, and a presentation unit. The acquisition unit acquires viewpoint information related to a designated virtual viewpoint corresponding to a virtual viewpoint image generated based on a plurality of captured images acquired by a plurality of imaging apparatuses. The determination unit determines an object, which is included in at least any of the plurality of captured images, the object being included in a range within a field of view of the virtual viewpoint specified by the viewpoint information acquired by the acquisition unit. The presentation unit presents information corresponding to a determination result by the determination unit for a plurality of virtual viewpoints specified by the viewpoint information acquired by the acquisition unit.

### SUMMARY

An embodiment according to the technology of the present disclosure provides an information processing apparatus, an information processing method, and a program capable of easily generating sympathy among a plurality of viewers who view an image for viewing.

A first aspect according to the technology of the present disclosure relates to an information processing apparatus comprising a processor, and a memory built in or connected to the processor, in which the information processing apparatus generates an image for viewing to be viewed by a viewer based on an image obtained by imaging with an imaging apparatus, the processor acquires request information for requesting generation of the image for viewing, and executes generation processing of generating the image for viewing in accordance with the acquired request information, the request information includes setting information indicating setting of the image for viewing, and the generation processing is processing of generating the image for viewing to which viewer information related to the viewer of which the setting information is within a predetermined range is reflected in the request information of a plurality of the viewers.

A second aspect according to the technology of the present disclosure relates to the information processing apparatus according to the first aspect, in which the image for viewing includes a virtual viewpoint image created based on the image.

A third aspect according to the technology of the present disclosure relates to the information processing apparatus according to the second aspect, of which the setting information includes gaze position specification information for specifying a gaze position used to generate the virtual viewpoint image in a region indicated by the image.

A fourth aspect according to the technology of the present disclosure relates to the information processing apparatus according to the third aspect, in which the gaze position is a position of a specific object included in the region.

A fifth aspect according to the technology of the present disclosure relates to the information processing apparatus according to the third or fourth aspect, in which the gaze position specification information includes a gaze position path information indicating a path of the gaze position.

A sixth aspect according to the technology of the present disclosure relates to the information processing apparatus according to any one of the second to fifth aspects, in which the processor generates the image for viewing by superimposing the viewer information related to the viewer of which the setting information is within the predetermined range on the virtual viewpoint image.

A seventh aspect according to the technology of the present disclosure relates to the information processing apparatus according to any one of the first to sixth aspects, in which the image for viewing includes at least one of audible data related to the viewer of which the setting information is within the predetermined range or visible data related to the viewer of which the setting information is within the predetermined range.

An eighth aspect according to the technology of the present disclosure relates to the information processing apparatus according to the seventh aspect, in which the image for viewing is a video, and the processor generates the image for viewing to which the viewer information is reflected, by adding at least one of the audible data or the visible data to the image for viewing at a timing set by the viewer at a time of playback of the image for viewing.

A ninth aspect according to the technology of the present disclosure relates to the information processing apparatus according to any one of the first to eighth aspects, in which the image for viewing includes a viewer specification image for visually specifying the viewer of which the setting information is within the predetermined range.

A tenth aspect according to the technology of the present disclosure relates to the information processing apparatus according to any one of the first to ninth aspects, in which the processor stores the viewer information in the memory, and generates the image for viewing to which the viewer information stored in the memory is reflected.

An eleventh aspect according to the technology of the present disclosure relates to the information processing apparatus according to any one of the first to tenth aspects, in which the viewer information includes an attribute related to a taste of the viewer.

A twelfth aspect according to the technology of the present disclosure relates to the information processing apparatus according to any one of the first to eleventh aspects, in which the request information includes the viewer information.

A thirteenth aspect according to the technology of the present disclosure relates to the information processing apparatus according to the first aspect, of which the setting information includes information related to which of a plurality of videos obtained by imaging with a plurality of the imaging apparatuses is to be viewed.

A fourteenth aspect according to the technology of the present disclosure relates to the information processing apparatus according to the thirteenth aspect, in which the processor generates a video for viewing by superimposing the viewer information related to the viewer of which the setting information is within the predetermined range on the video to be viewed.

A fifteenth aspect according to the technology of the present disclosure relates to the information processing apparatus according to the first aspect, of which the setting information includes information related to which of a plurality of edited videos created based on a plurality of videos obtained by imaging with a plurality of the imaging apparatuses is viewed.

A sixteenth aspect according to the technology of the present disclosure relates to the information processing apparatus according to the fifteenth aspect, in which the processor generates a video for viewing by superimposing the viewer information related to the viewer of which the setting information is within the predetermined range on the edited video to be viewed.

A seventeenth aspect according to the technology of the present disclosure relates to an information processing method of generating an image for viewing to be viewed by a viewer based on an image obtained by imaging with an imaging apparatus, the method comprising acquiring request information for requesting generation of the image for viewing, and executing generation processing of generating the image for viewing in accordance with the acquired request information, in which the request information includes setting information indicating setting of the image for viewing, and the generation processing is processing of generating the image for viewing to which viewer information related to the viewer of which the setting information is within a predetermined range is reflected in the request information of a plurality of the viewers.

An eighteenth aspect according to the technology of the present disclosure relates to a program causing a computer to execute information processing of generating an image for viewing to be viewed by a viewer based on an image obtained by imaging with an imaging apparatus, the information processing comprising acquiring request information for requesting generation of the image for viewing, and executing generation processing of generating the image for viewing in accordance with the acquired request information, in which the request information includes setting information indicating setting of the image for viewing, and the generation processing is processing of generating the image for viewing to which viewer information related to the viewer of which the setting information is within a predetermined range is reflected in the request information of a plurality of the viewers.

### BRIEF DESCRIPTION OF THE DRAWINGS

Exemplary embodiments of the technology of the disclosure will be described in detail based on the following figures, wherein:

FIG. 1 is a conceptual diagram showing an example of an external configuration of an information processing system according to a first embodiment;

FIG. 2 is a block diagram showing an example of a hardware configuration of an electric system of an information processing apparatus and an example of a relationship between the information processing apparatus and peripheral devices thereof;

FIG. 3 is a block diagram showing an example of a hardware configuration of an electric system of a user device;

FIG. 4 is a block diagram showing an example of a function of a main part of the information processing apparatus according to the first embodiment;

FIG. 5 is a block diagram showing an example of a processing content of an information acquisition unit according to the first embodiment;

FIG. 6 is a conceptual diagram showing an example of an information acquisition screen according to the first embodiment;

FIG. 7 is a block diagram showing an example of a processing content of a virtual viewpoint image generation unit according to the first embodiment;

FIG. 8 is a conceptual diagram showing an example of a processing content in a case in which a gaze position is a gaze object;

FIG. 9 is a block diagram showing an example of a processing content of an image-for-viewing generation unit according to the first embodiment;

FIG. 10 is a flowchart showing an example of a flow of video-for-viewing generation processing according to the first embodiment;

FIG. 11 is a conceptual diagram showing an example of a processing content in a case in which gaze position specification information includes gaze position path information;

FIG. 12 is a block diagram showing an example of a processing content of the image-for-viewing generation unit in a case in which the gaze position specification information includes the gaze position path information;

FIG. 13 is a conceptual diagram showing an example of the gaze position within a predetermined range;

FIG. 14 is a flowchart showing an example of a flow of video-for-viewing generation processing according to a modification example of the first embodiment;

FIG. 15 is a conceptual diagram showing an example of an external configuration of an information processing system according to a second embodiment;

FIG. 16 is a block diagram showing an example of a function of a main part of the information processing apparatus according to the second embodiment;

FIG. 17 is a conceptual diagram showing an example of an information acquisition screen according to the second embodiment;

FIG. 18 is a conceptual diagram showing an example of a video selection screen according to the second embodiment;

FIG. 19 is a block diagram showing an example of a processing content of an image-for-viewing generation unit according to the second embodiment;

FIG. 20 is a flowchart showing an example of a flow of video-for-viewing generation processing according to the second embodiment;

FIG. 21 is a conceptual diagram showing an example of an external configuration of an information processing system according to a third embodiment;

FIG. 22 is a conceptual diagram showing an example of a video selection screen according to the third embodiment;

FIG. 23 is a block diagram showing an example of a processing content of an image-for-viewing generation unit according to the third embodiment; and

FIG. 24 is a block diagram showing an example of an aspect in which a video-for-viewing generation program is installed from a storage medium to a computer of the information processing apparatus.

### DETAILED DESCRIPTION

An example of embodiments of an information processing apparatus, an information processing method, and a program according to the technology of the present disclosure will be described with reference to the accompanying drawings.

First, the terms used in the following description will be described.

CPU refers to an abbreviation of “Central Processing Unit”. RAM refers to an abbreviation of “Random Access Memory”. SSD refers to an abbreviation of “Solid State Drive”. HDD refers to an abbreviation of “Hard Disk Drive”. EEPROM refers to an abbreviation of “Electrically Erasable and Programmable Read Only Memory”. I/F refers to an abbreviation of “Interface”. IC refers to an abbreviation of “Integrated Circuit”. ASIC refers to an abbreviation of “Application Specific Integrated Circuit”. PLD refers to an abbreviation of “Programmable Logic Device”. FPGA refers to an abbreviation of “Field-Programmable Gate Array”. SoC refers to an abbreviation of “System-on-a-chip”. CMOS refers to an abbreviation of “Complementary Metal Oxide Semiconductor”. CCD refers to an abbreviation of “Charge Coupled Device”. EL refers to an abbreviation of “Electro-Luminescence”. GPU refers to an abbreviation of “Graphics Processing Unit”. LAN refers to an abbreviation of “Local Area Network”. 3D refers to an abbreviation of an abbreviation for “three (3) Dimensional”. USB refers to an abbreviation of “Universal Serial Bus”. ID refers to an abbreviation of “Identification”. In the following, for convenience of description, a CPU is described as an example of a “processor” according to the technology of the present disclosure. However, the “processor” according to the technology of the present disclosure may be a combination of a plurality of processing apparatuses, such as a CPU and a GPU. In a case in which the combination of the CPU and the GPU is applied as an example of the “processor” according to the technology of the present disclosure, the GPU is operated under the control of the CPU and is responsible for executing the image processing.

In the following description, “match” refers to the match in the sense of including an error generally allowed in the technical field to which the technology of the present disclosure belongs, that is the error to the extent that it does not contradict the purpose of the technology of the present disclosure, in addition to the exact match. In addition, “the same time point” refers to the same time point in the sense of including an error generally allowed in the technical field to which the technology of the present disclosure belongs, that is the error to the extent that it does not contradict the purpose of the technology of the present disclosure, in addition to the exact same time point.

### First Embodiment

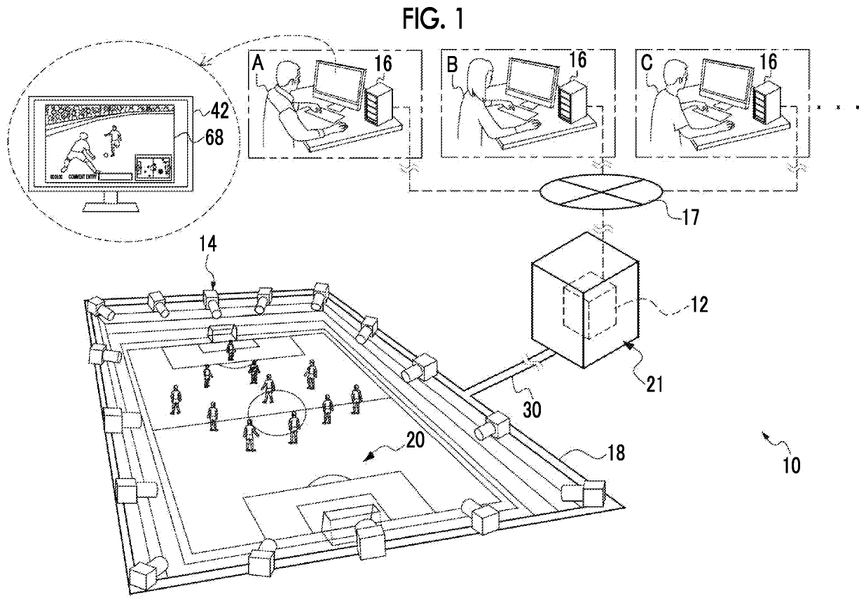

As shown in FIG. 1 as an example, an information processing system 10 comprises an information processing apparatus 12, a plurality of imaging apparatuses 14 connected to the information processing apparatus 12, and a plurality of user devices 16.

The imaging apparatus 14 is a device for imaging having a CMOS image sensor, and has an optical zoom function and/or a digital zoom function. It should be noted that another type of image sensor, such as a CCD image sensor, may be adopted instead of the CMOS image sensor. The imaging apparatus 14 is an example of an “imaging apparatus” according to the technology of the present disclosure.

The plurality of imaging apparatuses 14 are installed in a soccer stadium 18. Each of the plurality of imaging apparatuses 14 is disposed to surround a soccer field 20, and images a region in the soccer stadium 18 as an imaging region. Here, the form example is described in which the plurality of imaging apparatuses 14 is disposed to surround the soccer field 20. However, the technology of the present disclosure is not limited to this, and the disposition of the plurality of imaging apparatuses 14 is decided in accordance with a virtual viewpoint image requested to be generated by a user A, a user B, a user C, or the like. The plurality of imaging apparatuses 14 may be disposed to surround the entire soccer field 20 or may be disposed to surround a specific part thereof.

The imaging with the imaging apparatus 14 refers to, for example, imaging at an angle of view including the imaging region. Here, the concept of “imaging region” includes the concept of a region indicating a part of the soccer stadium 18, in addition to the concept of a region indicating the entire soccer stadium 18. The imaging region is changed in accordance with an imaging position, an imaging direction, and the angle of view of the imaging apparatus 14.

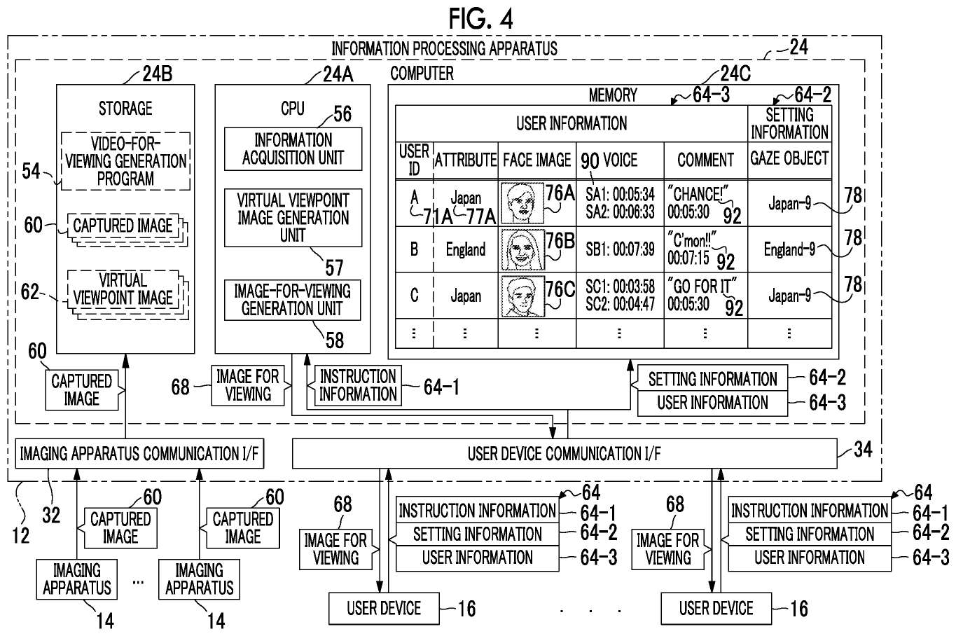

The information processing apparatus 12 is installed in the control room 21. The plurality of imaging apparatuses 14 and the information processing apparatus 12 are connected via a cable 30 (for example, a LAN cable). The information processing apparatus 12 controls the plurality of imaging apparatuses 14, and acquires a captured image 60 (see FIG. 4) obtained by imaging with each of the plurality of imaging apparatuses 14. It should be noted that, here, although the connection using a wired communication method by the cable 30 is described as an example, the technology of the present disclosure is not limited to this, and the connection using a wireless communication method may be used. The captured image 60 acquired by each imaging apparatus 14 is an example of an “image” according to the technology of the present disclosure.

The plurality of user devices 16 are personal computers. The user device 16 is connected to the information processing apparatus 12 via a communication network 17 (for example, the Internet). It should be noted that, in the first embodiment, the personal computer is applied as an example of the user device 16, but the personal computer is merely an example. The user device 16 may be, for example, a portable multifunctional terminal, such as a smartphone, a tablet terminal, or a head-mounted display, or may be a large-sized display used in a public viewing venue or the like.

The information processing apparatus 12 is a device corresponding to a server, and the user device 16 is a device corresponding to a client terminal with respect to the information processing apparatus 12. The information processing apparatus 12 and the user device 16 communicate with each other via the communication network 17, and the user device 16 requests the information processing apparatus 12 to provide an image for viewing 68. The information processing apparatus 12 generates the image for viewing 68 based on the captured image 60 (see FIG. 4) obtained by imaging with the imaging apparatus 14 in response to the request from the user device 16, and then transmits the generated image for viewing 68 to the user device 16. It should be noted that the information processing apparatus 12 is an example of an “information processing apparatus” according to the technology of the present disclosure. The image for viewing 68 is an example of an “image for viewing” according to the technology of the present disclosure.

Each of the plurality of user devices 16 is used by the users A, B, and C who are present outside the soccer stadium 18. Each of the users A, B, and C views the image for viewing 68 provided by the information processing apparatus 12 by using the user device 16. The users A, B, and C are examples of a “viewer” according to the technology of the present disclosure. FIG. 1 shows three users A, B, and C as the users who view the image for viewing 68, but the number of users is not limited to this, and the number of users may be more than or less than three. In addition, a plurality of users may view the image for viewing 68 via one user device 16. In the following, in a case in which it is not necessary to distinguish between the users A, B, and C, the users A, B, and C are collectively referred to as a “user” without a reference numeral.

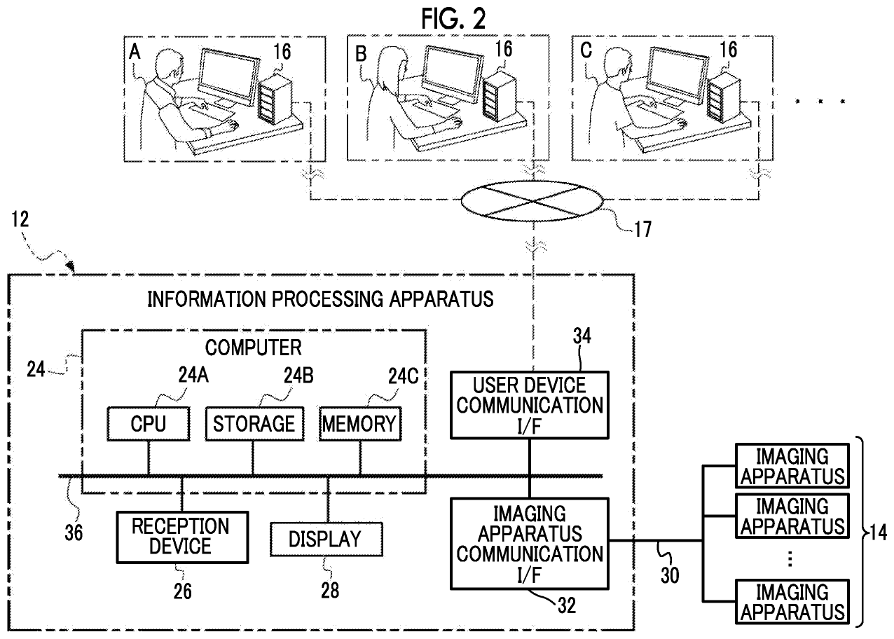

As shown in FIG. 2 as an example, the information processing apparatus 12 comprises a computer 24, a reception device 26, a display 28, an imaging apparatus communication I/F 32, and a user device communication I/F 34. The computer 24 comprises a CPU 24A, a storage 24B, and a memory 24C, and the CPU 24A, the storage 24B, and the memory 24C are connected to each other via a bus 36. In the example shown in FIG. 2, one bus is shown as the bus 36 for convenience of illustration, but a plurality of buses may be used. In addition, the bus 36 may include a serial bus or a parallel bus configured by a data bus, an address bus, a control bus, and the like.

The CPU 24A controls the entire information processing apparatus 12. The storage 24B stores various parameters and various programs. The storage 24B is a non-volatile storage device. Here, an EEPROM, an SSD, and an HDD are adopted as an example of the storage 24B, but the technology of the present disclosure is not limited to this, and an HDD, an SSD, an EEPROM, or the like may be used, or a combination of a plurality of these non-volatile storage devices may be used. The memory 24C is a storage device. Various information are transitorily stored in the memory 24C. The memory 24C is used as a work memory by the CPU 24A. Here, an RAM is adopted as an example of the memory 24C, but the technology of the present disclosure is not limited to this, and another type of storage device may be used. In addition, the memory 24C may be a memory built in the CPU 24A. It should be noted that the CPU 24A is an example of a “processor” according to the technology of the present disclosure. In addition, the memory 24C is an example of a “memory” according to the technology of the present disclosure.

The reception device 26 receives an instruction from a manager or the like of the information processing apparatus 12. Examples of the reception device 26 include a keyboard, a touch panel, and a mouse. The reception device 26 is connected to the bus 36 and the like, and the CPU 24A acquires the instruction received by the reception device 26.

The display 28 is connected to the bus 36 and displays various information under the control of the CPU 24A. Examples of the display 28 include a liquid crystal display. It should be noted that another type of display, such as an EL display (for example, an organic EL display or an inorganic EL display), may be adopted as the display 28 without being limited to the liquid crystal display.

The imaging apparatus communication I/F 32 is connected to the cable 30. The imaging apparatus communication I/F 32 is realized by a device including an FPGA, for example. The imaging apparatus communication I/F 32 is connected to the bus 36 and controls the exchange of various information between the CPU 24A and the plurality of imaging apparatuses 14. For example, the imaging apparatus communication I/F 32 controls the plurality of imaging apparatuses 14 in response to the request of the CPU 24A. In addition, the imaging apparatus communication I/F 32 stores the captured image 60 obtained by imaging with each of the plurality of imaging apparatuses 14 in the storage 24B (see FIG. 4). It should be noted that, here, although the wired communication I/F is described as an example of the imaging apparatus communication I/F 32, a wireless communication I/F, such as a high-speed wireless LAN, may be used.

The user device communication I/F 34 is connected to the user device 16 via the communication network 17 in a communicable manner. The user device communication I/F 34 is realized by a device including an FPGA, for example. The user device communication I/F 34 is connected to the bus 36. The user device communication I/F 34 controls the exchange of various information between the CPU 24A and the user device 16 via the communication network 17 by a wireless communication method. It should be noted that, at least one of the imaging apparatus communication I/F 32 or the user device communication I/F 34 can be configured by a fixed circuit instead of an FPGA. In addition, at least one of the imaging apparatus communication I/F 32 or the user device communication I/F 34 may be a circuit configured by an ASIC, an FPGA, and/or a PLD.

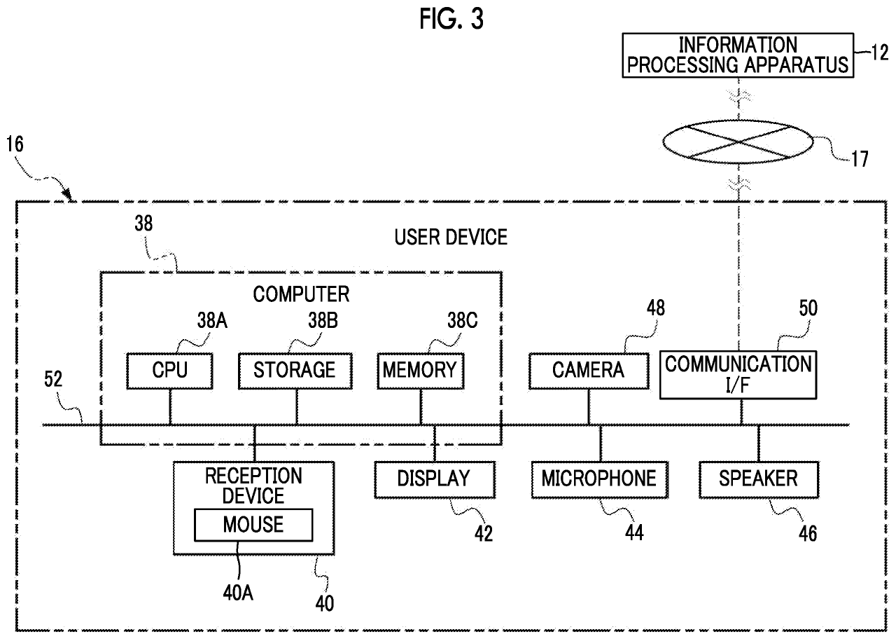

As shown in FIG. 3 as an example, the user device 16 comprises a computer 38, a reception device 40, a display 42, a microphone 44, a speaker 46, a camera 48, and a communication I/F 50. The computer 38 comprises a CPU 38A, a storage 38B, and a memory 38C, and the CPU 38A, the storage 38B, and the memory 38C are connected to each other via a bus 52. In the example shown in FIG. 3, one bus is shown as the bus 52 for convenience of illustration, but the bus 52 may be a plurality of buses. The bus 52 may be a serial bus, or may be a parallel bus including a data bus, an address bus, a control bus, and the like.

The CPU 38A controls the entire user device 16. The storage 38B stores various parameters and various programs. The storage 38B is a non-volatile storage device. Here, a flash memory is adopted as an example of the storage 38B. The flash memory is merely an example, and examples of the storage 38B include various non-volatile memories, such as a magnetoresistive memory and/or a ferroelectric memory instead of the flash memory or in combination with the flash memory. In addition, the non-volatile storage device may be an EEPROM, an HDD, and/or an SSD. The memory 38C transitorily stores various information, and is used as a work memory by the CPU 38A. Examples of the memory 38C include a RAM, but the technology of the present disclosure is not limited to this, and other types of storage devices may be used.

The reception device 40 receives the instruction from the user or the like. The reception device 40 includes a mouse 40A and a keyboard (see FIG. 1). In addition, the reception device 40 may include a touch panel. The reception device 40 is connected to the bus 52, and the CPU 38A acquires the instruction received by the reception device 40.

The display 42 is connected to the bus 52 and displays various information under the control of the CPU 38A. Examples of the display 42 include a liquid crystal display. It should be noted that another type of display, such as an EL display (for example, an organic EL display or an inorganic EL display), may be adopted as the display 42 without being limited to the liquid crystal display.

The microphone 44 converts a collected sound into an electric signal. The microphone 44 is connected to the bus 52. The CPU 38A acquires the electric signal obtained by converting the sound collected by the microphone 44 via the bus 52.

The speaker 46 converts the electric signal into the sound. The speaker 46 is connected to the bus 52. The speaker 46 receives the electric signal output from the CPU 38A via the bus 52, converts the received electric signal into the sound, and outputs the sound obtained by the conversion from the electric signal to the outside of the user device 16. Here, the speaker 46 is integrated with the user device 16, but the sound output from a headphone connected to the user device 16 by wire or wirelessly may be adopted. It should be noted that the headphone also includes an earphone.

The camera 48 acquires an image showing a subject by imaging the subject. The camera 48 is connected to the bus 52. The image obtained by imaging the subject by the camera 48 is acquired by the CPU 38A via the bus 52.

The communication I/F 50 is connected to the information processing apparatus 12 via the communication network 17 in a communicable manner. The communication I/F 50 is realized by, for example, a device configured by a circuit (for example, an ASIC, an FPGA, and/or a PLD). The communication I/F 50 is connected to the bus 52. The communication I/F 50 controls the exchange of various information between the CPU 38A and the information processing apparatus 12 via the communication network 17 by a wireless communication method.

As an example, as shown in FIG. 4, in the information processing apparatus 12, a video-for-viewing generation program 54 is stored in the storage 24B. The CPU 24A reads out the video-for-viewing generation program 54 from the storage 24B, and executes the read out video-for-viewing generation program 54 on the memory 24C. The CPU 24A is operated as an information acquisition unit 56, a virtual viewpoint image generation unit 57, and an image-for-viewing generation unit 58 in accordance with the video-for-viewing generation program 54 executed on the memory 24C to execute video-for-viewing generation processing described below. It should be noted that the video-for-viewing generation program 54 is a program causing the computer 24 to execute processing, and is an example of a “program” according to the technology of the present disclosure. In addition, the computer 24 is an example of a “computer” according to the technology of the present disclosure.

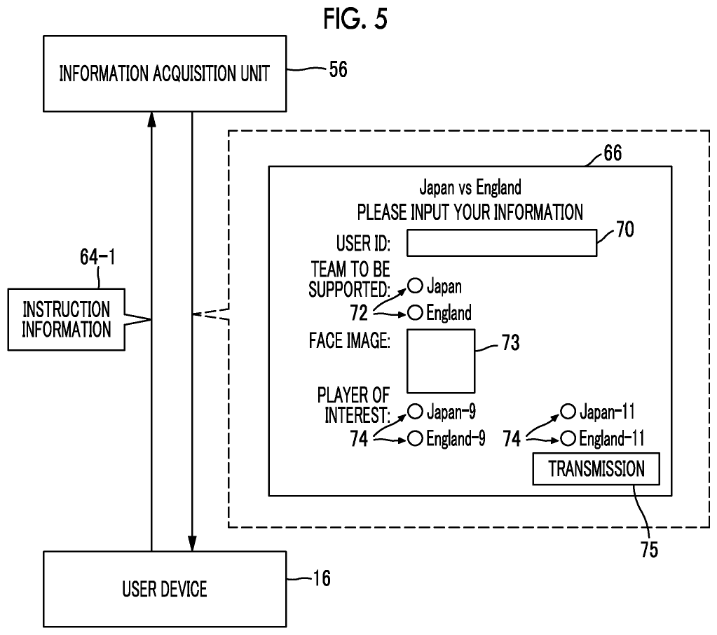

The CPU 24A acquires request information 64 for requesting the generation of the image for viewing 68 from each user device 16 via the user device communication I/F 34. The request information 64 includes instruction information 64-1 for instructing the display of an information acquisition screen 66 (see FIG. 5), setting information 64-2 that indicates the setting of the image for viewing 68, and user information 64-3 that indicates information related to the user. It should be noted that the request information 64 is an example of “request information” according to the technology of the present disclosure.

The CPU 24A executes the video-for-viewing generation processing of generating the image for viewing 68 in accordance with the acquired request information 64. Although the video-for-viewing generation processing will be described in detail below, the video-for-viewing generation processing is processing of generating the image for viewing 68 to which the user information 64-3 related to the user of which the setting information 64-2 is within a predetermined range is reflected, in the request information 64 from the plurality of users. It should be noted that the video-for-viewing generation processing is an example of “generation processing” according to the technology of the present disclosure. In addition, the setting information 64-2 is an example of “setting information” according to the technology of the present disclosure, and the user information 64-3 is an example of “viewer information” according to the technology of the present disclosure.

The information acquisition unit 56 receives the setting information 64-2 and the user information 64-3 of the user A via the user device communication I/F 34, and stores the received setting information 64-2 and user information 64-3 in the memory 24C. A name of a team to be supported is stored as an attribute 77A related to a taste of the user. A user ID 71A, the attribute 77A, and a face image 76A are stored in the memory 24C as the user information 64-3. Information related to a player of interest will be described in detail below, but the information is information used as a gaze object 78 in a case in which the virtual viewpoint image generation unit 57 generates the virtual viewpoint image, and is stored in the memory 24C as the setting information 64-2. The attribute 77A is an example of an “attribute” according to the technology of the present disclosure.

In the memory 24C, the setting information 64-2 and the user information 64-3 of each user acquired from each user device 16 by using the information acquisition screen 66 are stored in association with each other for each user. It should be noted that, in FIG. 4, a reference numeral 76B indicates a face image of the user B, and a reference numeral 76C indicates a face image of the user C. In addition, in a case in which it is not necessary to distinguish between the face images 76A, 76B, and 76C, the face images 76A, 76B, and 76C are collectively referred to as a “face image 76”. The face image 76 is an example of a “viewer specification image” according to the technology of the present disclosure.

The virtual viewpoint image generation unit 57 generates a virtual viewpoint image 62 based on the captured image 60 stored in the storage 24B and the setting information 64-2 received from each user. The virtual viewpoint image 62 is an image generated by image processing from the captured image 60, and is an image corresponding to a case in which the imaging region is viewed from any viewpoint (virtual viewpoint). It should be noted that the virtual viewpoint image 62 is an example of a “virtual viewpoint image” according to the technology of the present disclosure.

The setting information 64-2 includes gaze position specification information for specifying a gaze position 80 used to generate the virtual viewpoint image 62 in the region indicated by the captured image 60. In the first embodiment, the gaze position 80 is a position of a specific object included in the region indicated by the captured image 60, and is, for example, a position of a player designated as the player of interest.

The video-for-viewing generation processing will be specifically described below. The video-for-viewing generation processing is executed by the CPU 24A in a case in which the instruction information 64-1 of the request information 64 is received from at least one of the plurality of user devices 16. As shown in FIG. 5 as an example, in a case in which the instruction information 64-1 is received from the user device 16, the information acquisition unit 56 first generates the information acquisition screen 66 in accordance with a predetermined format. The information acquisition unit 56 transmits the generated information acquisition screen 66 to the user device 16 which is an output source of the instruction information 64-1.

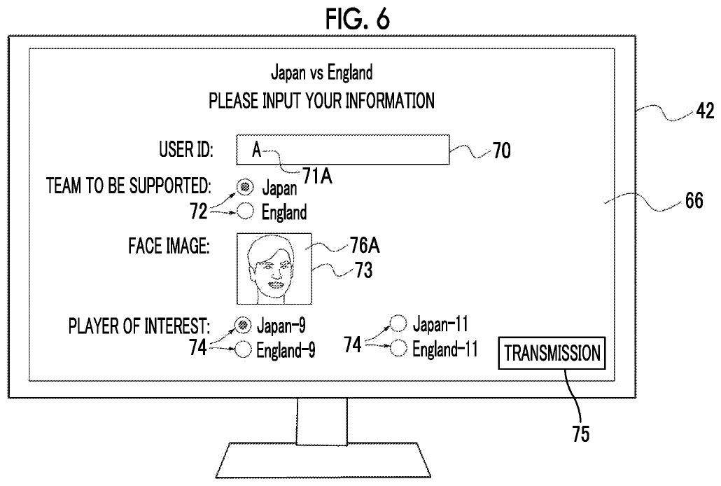

As shown in FIG. 6 as an example, the user device 16 receives the information acquisition screen 66, and displays the received information acquisition screen 66 on the display 42. FIG. 6 shows the information acquisition screen 66 displayed on the display 42 of the user device 16 of the user A. On an upper side of the information acquisition screen 66, the title “Japan vs England” of the image for viewing 68 that the user A wants to view and the message “Please input your information” prompting the user A to input the information are displayed. Further, on the information acquisition screen 66, an input field 70 for inputting the user ID 71A of the user A, a selection button 72 for selecting the team to be supported by the user A, a display frame 73 for displaying the input face image, a selection button 74 for selecting the player that the user A is interested in, and a transmission button 75 are displayed.

The user A inputs the user ID 71A from the reception device 40 into the input field 70. In addition, the user A selects the team to be supported by the user A by clicking one of the selection buttons 72 with the mouse 40A. In the example shown in FIG. 6, “Japan” is selected as the team to be supported.

In addition, for example, the user A causes the camera 48 of the user device 16 to image his/her own face, and drags an icon indicating the face image obtained by imaging with the camera 48 on the display frame 73 by using the mouse 40A. As a result, the face image 76A of the user A is displayed on the display frame 73.

Further, the user A selects the player of interest that he/her is interested in by clicking one of the selection buttons 74 with the mouse 40A. In the example shown in FIG. 6, the player is represented by the name of the team to which the player belongs and a uniform number of the player. For example, “Japan-9” represents a player with a uniform number “9” of the “Japan” team. In the example shown in FIG. 6, “Japan-9” is selected as the player of interest.

After inputting the information to the information acquisition screen 66, the user A clicks the transmission button 75 with the mouse 40A. As a result, the information input to the information acquisition screen 66 is transmitted to the information processing apparatus 12 from the user device 16 as the setting information 64-2 and the user information 64-3 of the user A.

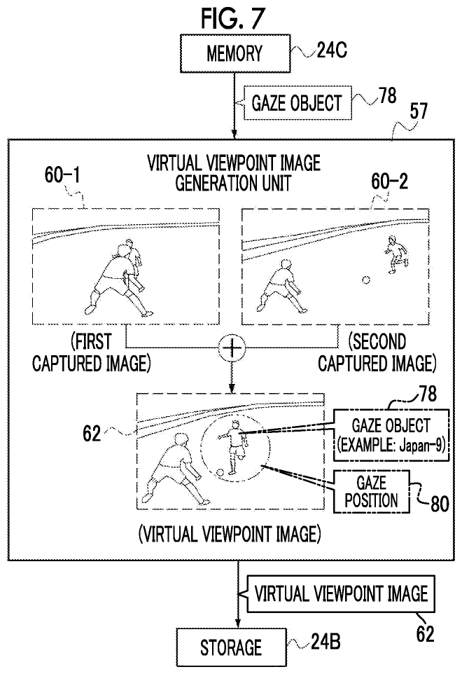

As shown in FIG. 7 as an example, the virtual viewpoint image generation unit 57 reads out the gaze object 78, which is stored in association with the user who is the output source of the request information 64, from the memory 24C. For example, in a case in which the virtual viewpoint image generation unit 57 generates the virtual viewpoint image 62 in accordance with the request information 64 from the user A, the gaze object 78 is the player (Japan-9) with the uniform number 9 of the Japan team. The virtual viewpoint image generation unit 57 acquires the coordinates of the gaze object 78 in the soccer stadium 18, and decides a region having a radius of several meters (for example, 1 m) about the coordinates as the gaze position 80. Here, the radius of several meters is described as an example, but the technology of the present disclosure is not limited to this, and a radius of several tens of meters or more may be used. In addition, the radius may be a fixed value or may be a variable value which is changed in response to an instruction given from the outside or a condition. It should be noted that the gaze object 78 is an example of a “specific object” according to the technology of the present disclosure. In addition, the gaze position 80 is an example of a “gaze position” according to the technology of the present disclosure. In addition, the coordinates and the radius of the gaze object 78 are an example of “gaze position specification information” according to the technology of the present disclosure.

The virtual viewpoint image generation unit 57 acquires a first captured image 60-1 and a second captured image 60-2 from the storage 24B. The first captured image 60-1 and the second captured image 60-2 are captured images acquired at the same time point by two different imaging apparatuses 14 among the plurality of imaging apparatuses 14. The virtual viewpoint image generation unit 57 generates the virtual viewpoint image 62 by generating a 3D polygon based on the first captured image 60-1 and the second captured image 60-2 with the gaze position 80 as a reference. The virtual viewpoint image generation unit 57 stores the generated virtual viewpoint image 62 in the storage 24B. It should be noted that the number of captured images used to generate the 3D polygon does not have to be two.

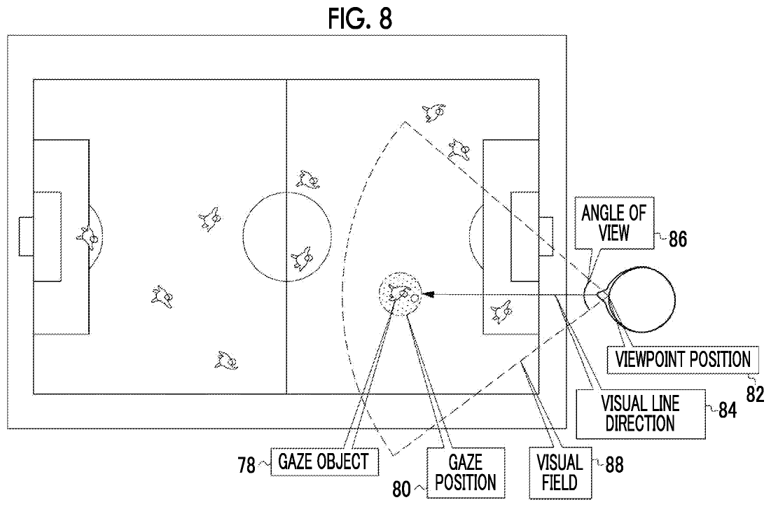

More specifically, as shown in FIG. 8 as an example, in a case in which the gaze object 78 is a person, the virtual viewpoint image generation unit 57 decides a viewpoint position 82 of the virtual viewpoint and a visual line direction 84 in a position and a direction facing the person. Further, the virtual viewpoint image generation unit 57 decides a visual field 88 of the virtual viewpoint image based on a predetermined angle of view 86. The virtual viewpoint image generation unit 57 generates the virtual viewpoint image 62 based on the decided visual field 88. That is, the virtual viewpoint image 62 is a virtual image in a case in which the imaging region is observed from the viewpoint position 82 in the visual line direction 84 at the angle of view 86.

The virtual viewpoint image generation unit 57 generates the virtual viewpoint image 62 for each gaze object 78. For example, in a case in which the user A and the user C designate “Japan-9” as the gaze object 78 and the user B designates “England-9” as the gaze object 78 (see FIG. 4), the virtual viewpoint image generation unit 57 generates the virtual viewpoint image 62 in which the position of “Japan-9” is the gaze position 80 and the virtual viewpoint image 62 in which the position of “England-9” is the gaze position 80, and stores the virtual viewpoint images 62 in the storage 24B. It should be noted that it is not necessary to generate the virtual viewpoint image 62 for all the gaze objects 78, and the virtual viewpoint image 62 may be generated only for the gaze object 78 designated by the user.

The image-for-viewing generation unit 58 superimposes the user information 64-3 related to the user of which the setting information 64-2 is the same on the virtual viewpoint image 62 corresponding to the setting information 64-2 of the user to generate the image for viewing 68. That is, in the first embodiment, the image for viewing 68 is the image including the virtual viewpoint image 62. In addition, the fact that the setting information 64-2 is the same is an example of “setting information is within a predetermined range” according to the technology of the present disclosure.

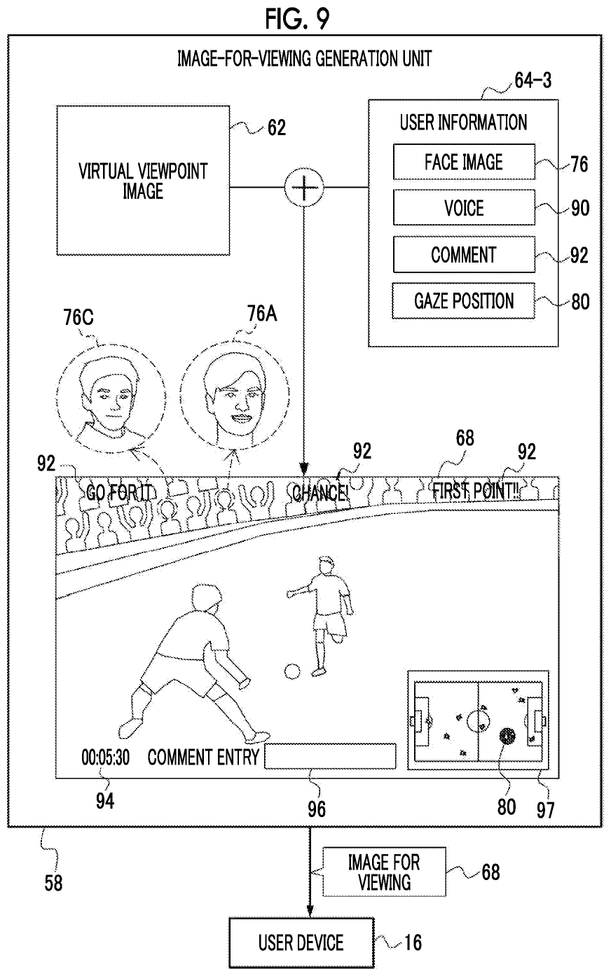

As shown in FIG. 9 as an example, in a case in which the request information 64 is received from the user A, the image-for-viewing generation unit 58 acquires the virtual viewpoint image 62 corresponding to the setting information 64-2 of the user A, that is, the virtual viewpoint image 62 in which the position of “Japan-9” is the gaze position 80 from the storage 24B. In addition, the image-for-viewing generation unit 58 acquires the user information 64-3 related to the user (user C or the like) who sets the same setting information 64-2 as the user A from the memory 24C. The image-for-viewing generation unit 58 generates the image for viewing 68 by superimposing the user information 64-3 acquired from the memory 24C on the virtual viewpoint image 62 acquired from the storage 24B. It should be noted that the user who sets the same setting information 64-2 as the user A may be a user who currently sets the same setting information 64-2, may be a user who has set the same setting information 64-2 in the past, or may be both the users described herein.

The image-for-viewing generation unit 58 generates the image for viewing 68 to which the user information 64-3 is reflected, by adding the face image 76 for visually specifying the user of which the setting information 64-2 is the same to the virtual viewpoint image 62. That is, in the example shown in FIG. 9, the image-for-viewing generation unit 58 superimposes the face image 76A of the user A and the face image 76C of the user C on the virtual viewpoint image 62 corresponding to the setting information 64-2 of the user A to generate the image for viewing 68. That is, in this example, the setting information 64-2 of the user A and the user C is the same. In this case, for example, in a case in which the user A views the image for viewing 68, it is not necessary to superimpose the face image 76A of the user A. In a case in which the user A views the image for viewing 68 on which the face image 76C of the user C is superimposed, the user A can obtain a feeling of viewing the image together with the user C. It should be noted that, in the example shown in FIG. 9, the face images 76A and 76C are superimposed on the spectator seats of the soccer stadium 18, but the position to which the face images 76A and 76C are added and the size are not limited to this. In addition, in the example shown in FIG. 9, the user A and the user C are associated with each other based on the setting information 64-2, and the image for viewing 68 to which the user information 64-3 of the user A and the user C is reflected is generated. However, the number of users associated with each other based on the setting information 64-2 is not limited to two. The image for viewing 68 to which the user information 64-3 of a large number of users having the same setting information 64-2 is reflected may be generated.

The image for viewing 68 is generated by the image-for-viewing generation unit 58 at a predetermined frame rate (for example, 60 fps). The series of the images for viewing 68 continuously generated by the image-for-viewing generation unit 58 at the predetermined frame rate is transmitted to the user device 16 as a video for viewing by the image-for-viewing generation unit 58. The user device 16 receives the video for viewing, and displays the received video for viewing on the display 42. It should be noted that the video for viewing is an example of a “video” according to the technology of the present disclosure. In addition, the image for viewing 68 may be displayed on the display 42 as a still image instead of the video for viewing.

On a lower side of the image for viewing 68, a time point 94, a comment entry field 96, a bird's-eye view image 97 showing the position of the gaze position 80 used to generate the virtual viewpoint image 62 are superimposed. The time point 94 indicates a playback time point of the video for viewing. The comment entry field 96 is an entry field for the user to enter a comment 92 while viewing the video for viewing. It should be noted that the image showing the position of the gaze position 80 is not limited to the bird's-eye view image 97 in which the imaging region is viewed from directly above, and may be an image in which the imaging region is viewed from diagonally above. Alternatively, the image showing the position of the gaze position 80 may be two images, the bird's-eye view image 97 and an image in which the imaging region is viewed from the side.

The image-for-viewing generation unit 58 generates the image for viewing 68 to which the user information 64-3 is reflected, by adding at least one of voice 90 from the user of which the setting information 64-2 is the same or the comment 92 from the user of which the setting information 64-2 is the same to the virtual viewpoint image 62. The voice 90 is a user's voice, music, or the like collected by the microphone 44 of each user device 16. The comment 92 is a character string input to the comment entry field 96 at any timing by the user using the reception device 40 while viewing the video for viewing displayed on the display 42 of the user device 16. It should be noted that the voice 90 is an example of “audible data” according to the technology of the present disclosure, and the comment 92 is an example of “visible data” according to the technology of the present disclosure.

The voice 90 and the comment 92 are, for example, transmitted to the image-for-viewing generation unit 58 from the user device 16 of the user C via the communication I/F 50 and the user device communication I/F 34. The image-for-viewing generation unit 58 receives the voice 90 and/or the comment 92, and adds the received voice 90 and/or comment 92 to the virtual viewpoint image 62 at a timing set by the user during the playback of the image for viewing 68. In this example, the voice 90 and/or the comment 92 is displayed on the user device 16 of the user A and/or is output from the user device 16 at a timing set by the user C. Here, the “timing set by the user” is a time point at which the voice 90 and/or the comment 92 is received by the image-for-viewing generation unit 58 at the playback time point of the video for viewing. For example, in a case in which the user C and the user A view the video for viewing at the same time, the voice 90 and/or the comment 92 of the user C is displayed on the user device 16 of the user A in real time and/or is output from the user device 16. It should be noted that the “timing set by the user” is not limited to this, and may be a time point or the like designated by the user from the reception device 40.

In addition, the image-for-viewing generation unit 58 stores the voice 90 and/or the comment 92 input from the user device 16 in association with the time point at which the voice 90 and/or the comment 92 is received as the user information 64-3 in the memory 24C for each user (see FIG. 4). The image-for-viewing generation unit 58 acquires the voice 90 and/or the comment 92 in addition to the face image 76 from the memory 24C, and generates the image for viewing 68 to which the voice 90 and/or the comment 92 is reflected. That is, the image-for-viewing generation unit 58 generates the image for viewing 68 by adding the voice 90 and/or the comment 92 acquired from the memory 24C to the virtual viewpoint image 62 at the time point associated with each data. For example, in a case in which the user C transmits the voice 90 and/or the comment 92 while viewing the video for viewing, the voice 90 and/or the comment 92 of the user C is stored in the memory 24C. The image-for-viewing generation unit 58 generates the image for viewing 68 as described above, so that the user A who view the video for viewing at a timing different from that of the user C can view the voice 90 and/or the comment 92 of the user C together with the video for viewing at the timing set by the user C.

In the example shown in FIG. 9, at the playback time point “00:05:30” of the video for viewing, the comment 92 of the user A, the comment 92 of the user (for example, the user B or the user C) who sets the same setting information 64-2 as the user A, and the like are added to the virtual viewpoint image 62 and displayed on the display 42. Similarly, the voice 90 is added to the image for viewing 68 at a time point associated with the voice data. That is, the voice 90 is played back by the speaker 46 of the user device 16 at the playback time point “00:05:30” of the video for viewing. In this case, the “timing set by the user” is the playback time point “00:05:30” of the video for viewing. It should be noted that the comment 92 may be continuously displayed, for example, for several seconds after the “timing set by the user”.

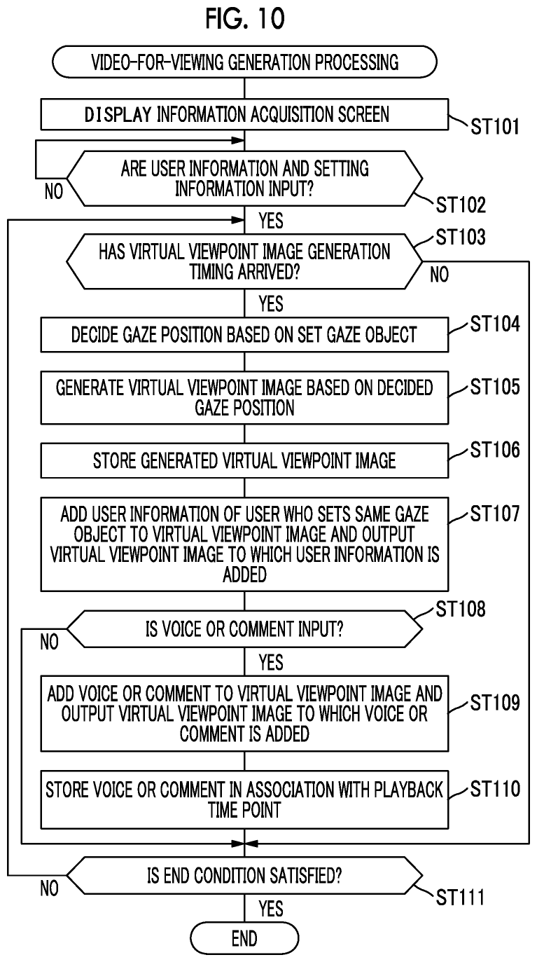

Next, an action of the information processing apparatus 12 according to the first embodiment will be described with reference to FIG. 10. The video-for-viewing generation processing shown in FIG. 10 is realized by the CPU 24A executing the video-for-viewing generation program 54. In addition, the video-for-viewing generation processing shown in FIG. 10 is started in a case in which the CPU 24A receives the instruction information 64-1 from at least one of the plurality of user devices 16.

In the video-for-viewing generation processing shown in FIG. 10, first, in step ST101, the information acquisition unit 56 generates the information acquisition screen 66, and transmits the generated information acquisition screen 66 to the user device 16 which is the output source of the instruction information 64-1. The user device 16 receives the information acquisition screen 66, and displays the received information acquisition screen 66 on the display 42. Thereafter, the video-for-viewing generation processing proceeds to step ST102.

In step ST102, the information acquisition unit 56 determines whether or not the user information 64-3 and the setting information 64-2 requested on the information acquisition screen 66 are input. In step ST102, in a case in which the user information 64-3 and the setting information 64-2 are input, a positive determination is made, and the video-for-viewing generation processing proceeds to step ST103. In step ST102, in a case in which the user information 64-3 and the setting information 64-2 are not input, a negative determination is made, and the video-for-viewing generation processing proceeds to step ST102.

In step ST103, the virtual viewpoint image generation unit 57 determines whether or not a timing for generating the virtual viewpoint image (hereinafter, also referred to as a “virtual viewpoint image generation timing”) has arrived. The virtual viewpoint image generation timing is, for example, a timing decided based on the predetermined frame rate constituting the video for viewing. In step ST103, in a case in which the virtual viewpoint image generation timing has arrived, a positive determination is made, and the video-for-viewing generation processing proceeds to step ST104. In step ST103, in a case in which the virtual viewpoint image generation timing has not arrived, a negative determination is made, and the video-for-viewing generation processing proceeds to step ST111.

In step ST104, the virtual viewpoint image generation unit 57 decides the gaze position 80 based on the gaze object 78 set as the setting information 64-2. Thereafter, the video-for-viewing generation processing proceeds to step ST105.

In step ST105, the virtual viewpoint image generation unit 57 generates the virtual viewpoint image 62 based on the gaze position 80 decided in step ST104. Thereafter, the video-for-viewing generation processing proceeds to step ST106.

In step ST106, the virtual viewpoint image generation unit 57 stores the virtual viewpoint image 62 generated in step ST105 in the storage 24B. Thereafter, the video-for-viewing generation processing proceeds to step ST107.

In step ST107, the image-for-viewing generation unit 58 adds the user information 64-3 of the user who is the output source of the instruction information 64-1 and the user information 64-3 of the user having the same gaze object 78 as the user who is the output source of the instruction information 64-1 to the virtual viewpoint image 62, and outputs the virtual viewpoint image 62 to which the user information 64-3 is added, to the user device 16 which is the output source of the instruction information 64-1 as the image for viewing 68. Thereafter, the video-for-viewing generation processing proceeds to step ST108.

In step ST108, the image-for-viewing generation unit 58 determines whether or not the voice 90 or the comment 92 of the user who is the output source of the instruction information 64-1 or the user having the same gaze object 78 is input. In step ST108, in a case in which the voice 90 or the comment 92 is input, a positive determination is made, and the video-for-viewing generation processing proceeds to step ST109. In step ST108, in a case in which the voice 90 or the comment 92 is not input, a negative determination is made, and the video-for-viewing generation processing proceeds to step ST111. It should be noted that the determination in step ST108 is not limited to the determination as to whether or not the voice 90 or the comment 92 is input in real time, and may include the determination as to whether or not the voice 90 or the comment 92 is input in advance for the same video for viewing.

In step ST109, the image-for-viewing generation unit 58 adds the input voice 90 or comment 92 to the virtual viewpoint image 62 in addition to the user information 64-3 of the user having the same gaze object 78. The image-for-viewing generation unit 58 transmits the virtual viewpoint image 62 to which the voice 90 or the comment 92 is added, as the image for viewing 68, to the user device 16 of the user who is the output source of the instruction information 64-1. Thereafter, the video-for-viewing generation processing proceeds to step ST110.

In step ST110, the image-for-viewing generation unit 58 stores the input voice 90 or comment 92 in the memory 24C in association with the playback time point of the video for viewing including the series of the images for viewing 68. Thereafter, the video-for-viewing generation processing proceeds to step ST111.

In step ST111, the image-for-viewing generation unit 58 determines whether or not an end condition is satisfied. Examples of the end condition include that imaging ends or that the stop button is operated. The stop button is displayed, for example, as a soft key on the display 42 of the user device 16. Specifically, the stop button is displayed in a playback screen including a video for viewing. In step ST111, in a case in which the end condition is satisfied, a positive determination is made, and the video-for-viewing generation processing ends. In step ST111, in a case in which the end condition is not satisfied, a negative determination is made, and the video-for-viewing generation processing proceeds to step ST103.

As described above, in the first embodiment, the information processing apparatus 12 comprises the CPU 24A and the memory 24C connected to the CPU 24A. The information processing apparatus 12 executes the video-for-viewing generation processing of generating the image for viewing 68 to be viewed by the user based on the captured image 60 obtained by imaging with the imaging apparatus 14. In the video-for-viewing generation processing, the information acquisition unit 56 of the CPU 24A acquires the request information 64 for requesting the generation of the image for viewing 68. The request information 64 includes the setting of the image for viewing 68, that is, the setting information 64-2 indicating the gaze position 80 of the virtual viewpoint image 62 included in the image for viewing 68. The virtual viewpoint image generation unit 57 of the CPU 24A generates the virtual viewpoint image 62 based on the acquired gaze position 80. The image-for-viewing generation unit 58 of the CPU 24A generates the image for viewing 68 to which the user information 64-3 is reflected, by using the generated virtual viewpoint image 62 and the user information 64-3 related to the user of which the setting information 64-2 is the same in the request information 64 of the plurality of users. Therefore, with the present configuration, it is possible to easily generate sympathy among the users who view the image for viewing 68, as compared with a case in which the user is made to view an unprocessed virtual viewpoint image 62 as it is.

In addition, in the first embodiment, the image for viewing 68 includes the virtual viewpoint image 62 created based on the captured image 60. Therefore, with the present configuration, it is possible for the user to view the image for viewing 68 including the virtual viewpoint image 62 observed from a free viewpoint, as compared with a case in which the image for viewing 68 does not include the virtual viewpoint image 62.

In addition, in the first embodiment, the setting information 64-2 includes the gaze position specification information for specifying the gaze position 80 used to generate the virtual viewpoint image 62 in the region indicated by the captured image 60. Therefore, with the present configuration, it is possible to easily generate sympathy among the users who view the image for viewing 68 including the same virtual viewpoint image 62.

In addition, in the first embodiment, the gaze position 80 is the position of the gaze object 78 included in the region indicated by the captured image 60. Therefore, with the present configuration, it is possible to easily generate sympathy among the plurality of users who view the image for viewing 68 including the virtual viewpoint image 62 generated based on the gaze position specification information indicating the same gaze object 78.

In addition, in the first embodiment, the image-for-viewing generation unit 58 generates the image for viewing 68 by superimposing the user information 64-3 related to the user of which the setting information 64-2 is the same on the virtual viewpoint image 62. Therefore, with the present configuration, it is possible to enhance a realistic effect of the image for viewing 68 as compared with a case in which the user information 64-3 related to the user of which the setting information 64-2 is the same is not superimposed on the virtual viewpoint image 62.

In addition, in the first embodiment, the image-for-viewing generation unit 58 generates the image for viewing 68 to which the user information 64-3 is reflected, by adding at least one of the voice 90 related to the user of which the setting information 64-2 is the same or the comment 92 related to the user of which the setting information 64-2 is the same. Therefore, with the present configuration, as compared with a case in which the voice 90 related to the user of which the setting information 64-2 is the same or the comment 92 related to the user of which the setting information 64-2 is the same is not added, it is possible to easily generate sympathy among the users who view the image for viewing 68 including the same virtual viewpoint image 62.

In addition, in the first embodiment, the image-for-viewing generation unit 58 generates the image for viewing 68 to which the user information 64-3 is reflected, by adding the face image 76 for visually specifying the user of which the setting information 64-2 is the same. Therefore, with the present configuration, as compared with a case in which the image for viewing 68 does not include the face image 76 for visually specifying the user, it is possible to easily generate sympathy among the users who view the image for viewing 68 including the same virtual viewpoint image 62.

In addition, in the first embodiment, the image for viewing 68 is the video, and the image-for-viewing generation unit 58 adds at least one of the voice 90 or the comment 92 to the image for viewing 68 at the timing set by the user during the playback of the image for viewing 68. Therefore, with the present configuration, as compared with a case in which at least one of the voice 90 or the comment 92 is not added to the image for viewing 68 at the timing set by the user, it is possible to easily generate sympathy among the users who view the image for viewing 68 in accordance with a scene of the image for viewing 68.

In addition, in the first embodiment, the image-for-viewing generation unit 58 stores the user information 64-3 in the memory 24C, and generates the image for viewing 68 to which the user information 64-3 stored in the memory 24C is reflected. Therefore, with the present configuration, it is not necessary for the user to input the user information 64-3 each time the image for viewing 68 is viewed, as compared with a case in which the user information 64-3 is not stored in the memory 24C.

In addition, in the first embodiment, the user information 64-3 includes the attribute related to the taste of the user. Therefore, with the present configuration, as compared with a case in which the image for viewing 68 is not generated by using the attribute related to the taste of the user, it is possible to generate the image for viewing 68 corresponding to the taste of the user.

In addition, in the first embodiment, the request information 64 includes the user information 64-3. Therefore, with the present configuration, it is possible to store the setting information 64-2 and the user information 64-3 included in the request information 64 in the memory 24C in association with each other.

In the first embodiment, the gaze position 80 used to generate the virtual viewpoint image 62 is the position of the gaze object 78, and the gaze position specification information is the coordinates and the radius of the gaze object 78, but the technology of the present disclosure is not limited to this. The gaze position 80 may be coordinates indicating the region in the soccer stadium 18 optionally designated by the user. In this case, the gaze position specification information may be coordinates of the gaze position 80. In addition, the gaze position specification information may be the viewpoint position 82 of the virtual viewpoint, the visual line direction 84, and the angle of view 86.

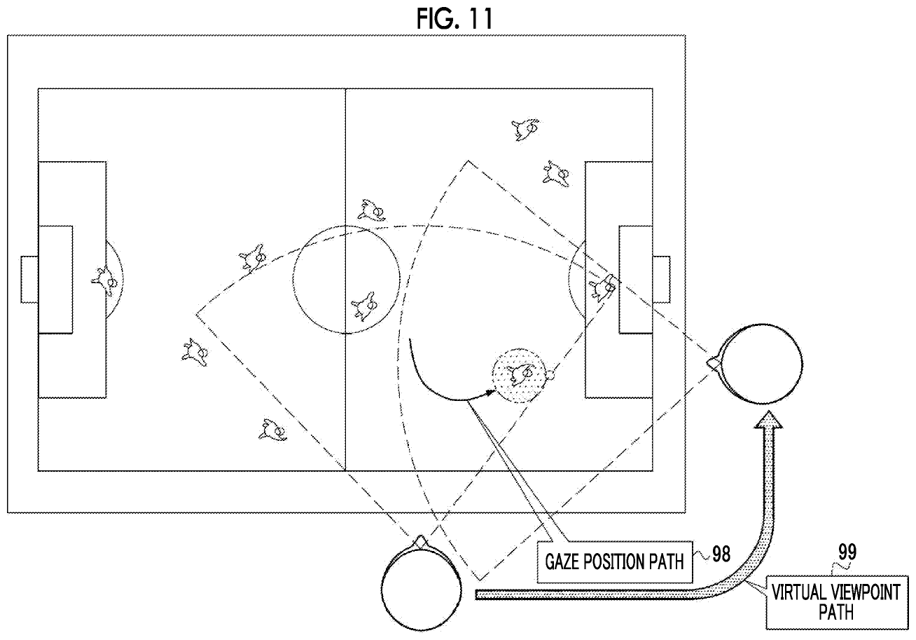

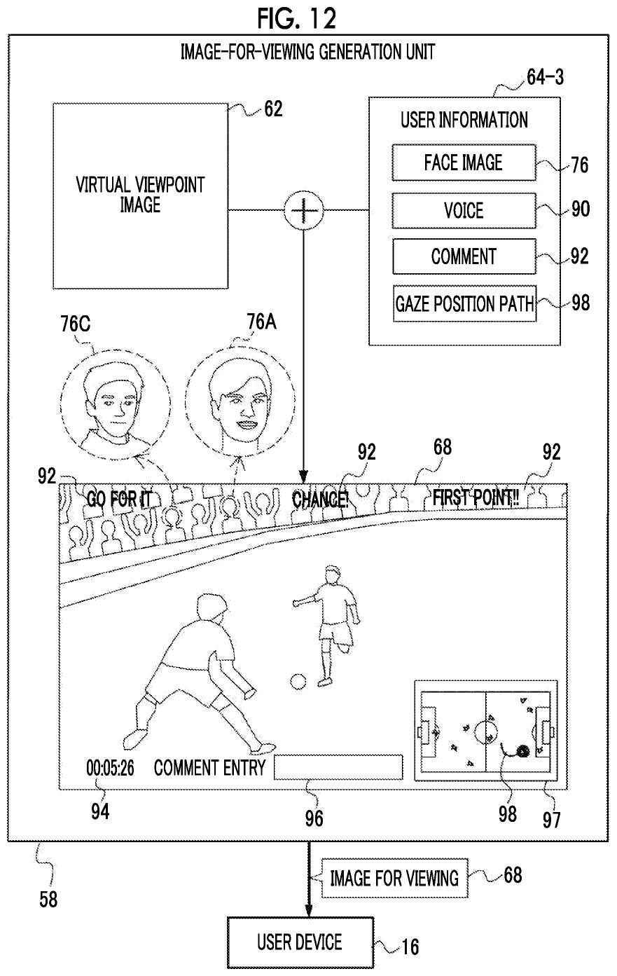

In addition, as shown in FIG. 11 as an example, the gaze position specification information for specifying the gaze position 80 may include a gaze position path 98 indicating a path of the gaze position 80. The gaze position path 98 can be said to be a set in which a plurality of gaze positions 80 are linearly linked. For example, in a case in which the gaze position 80 is a position of a specific player, the gaze position path 98 matches the locus of movement of the player. In this case, since the virtual viewpoint is set at the position and the direction facing the player, the virtual viewpoint path 99 is a path as shown in FIG. 11. In addition, as shown in FIG. 12 as an example, in the image for viewing 68, the gaze position path 98 may be displayed on the bird's-eye view image 97 and superimposed on the image for viewing 68. It should be noted that the gaze position path 98 is an example of “gaze position path information” according to the technology of the present disclosure.

In addition, in the first embodiment, the gaze object 78 is the specific player selected as the player of interest by the user on the information acquisition screen 66, but the technology of the present disclosure is not limited to this. The gaze object 78 may be an object, such as a ball, a goal, a line, or a pole, or may be an object optionally designated by the user from the region in the soccer stadium 18.

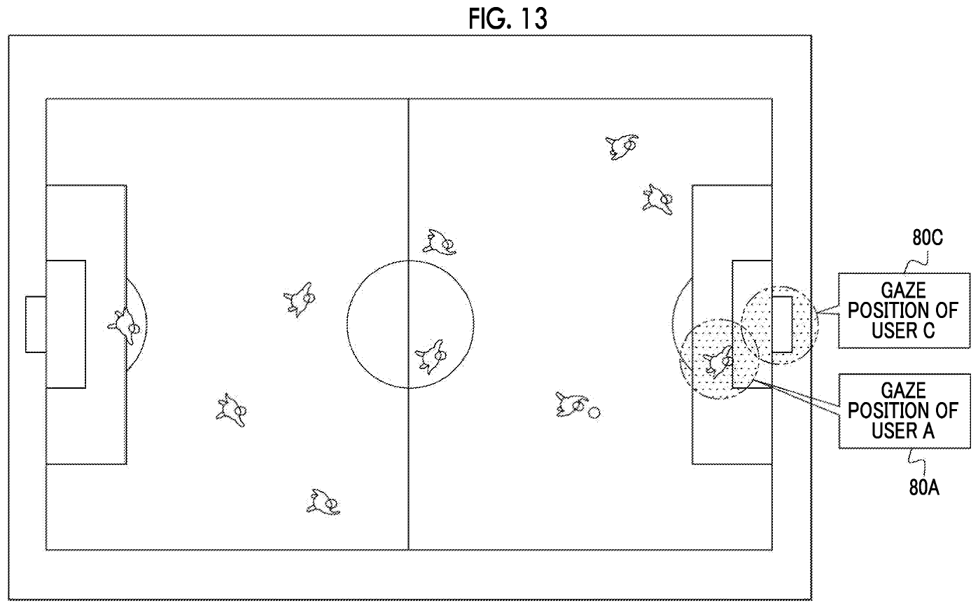

Specifically, as shown in FIG. 13 as an example, for example, the user A designates the specific player as the gaze object 78, and the user C designates a soccer goal as the gaze object 78. In this case, the gaze position 80A of the user A is decided at a position including the specific player, and the gaze position 80C of the user C is decided at a position including the soccer goal.

As described above, in a case in which the gaze position specification information includes the gaze position path 98 or in a case in which the position of the object optionally designated by the user is decided as the gaze position 80, the image-for-viewing generation unit 58 may generate the image for viewing 68 to which the user information 64-3 related to the user of which the gaze position 80 or the gaze position path 98 is within the predetermined range is reflected, instead of the user information 64-3 of the user of which the gaze position 80 is the same. In the example shown in FIG. 13, since the gaze position 80A of the user A and the gaze position 80C of the user C are within the predetermined range, the image-for-viewing generation unit 58 generates the image for viewing 68 by adding the user information 64-3 of the users A and C to the virtual viewpoint image 62.

In addition, in a case in which the gaze position specification information is the viewpoint position 82 of the virtual viewpoint, the visual line direction 84, and the angle of view 86, the image-for-viewing generation unit 58 may generate the image for viewing 68 to which the user information 64-3 related to the user in which at least one of the viewpoint position 82, the visual line direction 84, or the angle of view 86 is within the predetermined range is reflected. In addition, the image-for-viewing generation unit 58 may generate the image for viewing 68 to which the user information 64-3 related to the user in which the viewpoint position 82, the visual line direction 84, and the angle of view 86 are all within the predetermined range is reflected. It should be noted that the predetermined range is a value derived as a distance between the gaze positions 80 in which the similar virtual viewpoint images 62 are generated, for example, by a test using an actual machine and/or a computer simulation. The similar virtual viewpoint images 62 is, for example, images in which the same player can be viewed. In addition, the predetermined range may be a range decided without performing a computer simulation, or may be a range of numerical values roughly decided, for example, within 2 meters in the real space. Similarly, the fact that the gaze position path 98 is within the predetermined range may be, for example, that a distance between the paths is within a range of numerical values roughly decided such that the distance between the paths is within 2 meters on average. Alternatively, in a case in which the gaze position specification information is the viewpoint position 82 of the virtual viewpoint, the visual line direction 84, and the angle of view 86, the predetermined range is, for example, within 1 meter in the real space with respect to the viewpoint position 82 decided by the user, within 3 degrees with respect to the visual line direction 84 decided by the user, and within 10 degrees with respect to the angle of view 86 decided by the user. It should be noted that the predetermined range is not limited to these examples. In addition, the predetermined range may be changeable by the user. By enabling the user to change the predetermined range, for example, in a case in which the predetermined range is narrow in the initial setting and another user of which the setting information 64-2 is within the predetermined range of cannot be found, it is possible to find another user by changing the predetermined range. The predetermined range is an example of a “predetermined range” according to the technology of the present disclosure.

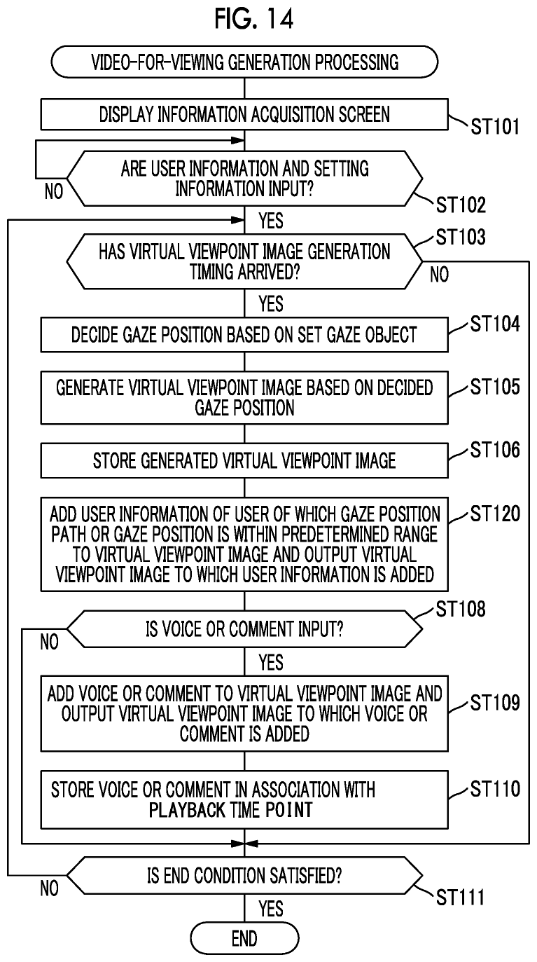

In this case, as shown in FIG. 14 as an example, step ST107 is replaced with step ST120 in the video-for-viewing generation processing performed by the CPU 24A. That is, in step ST120, the image-for-viewing generation unit 58 adds the user information 64-3 of the user of which the gaze position path 98 or the gaze position 80 is within the predetermined range to the virtual viewpoint image 62, and transmits the virtual viewpoint image 62 to which the user information 64-3 is added, to the user device 16 as the image for viewing 68. Since other steps are the same as those shown in FIG. 10, the description thereof will be omitted.

As described above, with the configuration in which the gaze position specification information includes the gaze position path 98, it is possible to easily generate sympathy among the users who view the image for viewing 68 including the virtual viewpoint images 62 generated based on the similar gaze position paths 98. In addition, with the configuration in which the position of the object optionally designated by the user is decided as the gaze position 80, it is possible to easily generate sympathy among the users who view the image for viewing 68 including the virtual viewpoint image 62 generated based on the gaze position 80 within the predetermined range.

### Second Embodiment

Although, in the first embodiment, the setting information 64-2 includes the gaze position specification information for specifying the gaze position 80 used to generate the virtual viewpoint image, in the second embodiment, the setting information 64-2 includes information related to which of a plurality of videos obtained by imaging with the plurality of imaging apparatuses 14 is to be viewed. In the second embodiment, the CPU 24A generates a video for viewing 168 by superimposing the user information 64-3 related to the user of which the setting information 64-2 is within the predetermined range on the video to be viewed. In the following, a difference from the first embodiment will be described. In the following description, the same configurations as those of the first embodiment will be represented by the same reference numerals as those of the first embodiment, and the same configurations and actions as those of the first embodiment will be omitted.

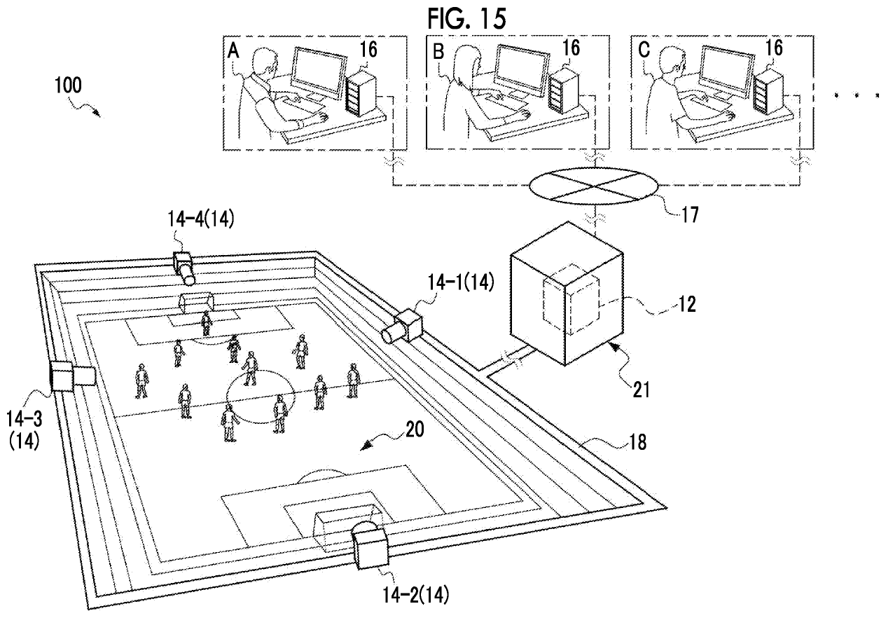

As shown in FIG. 15 as an example, in an information processing system 100 according to the second embodiment comprises, a first imaging apparatus 14-1, a second imaging apparatus 14-2, a third imaging apparatus 14-3, and a fourth imaging apparatus 14-4. The first to fourth imaging apparatuses 14-1 to 14-4 are disposed one by one on each of the four wall surfaces surrounding the soccer stadium 18 having a substantially rectangular shape. The first to fourth imaging apparatuses 14-1 to 14-4 image the region in the soccer stadium 18 as the imaging region.

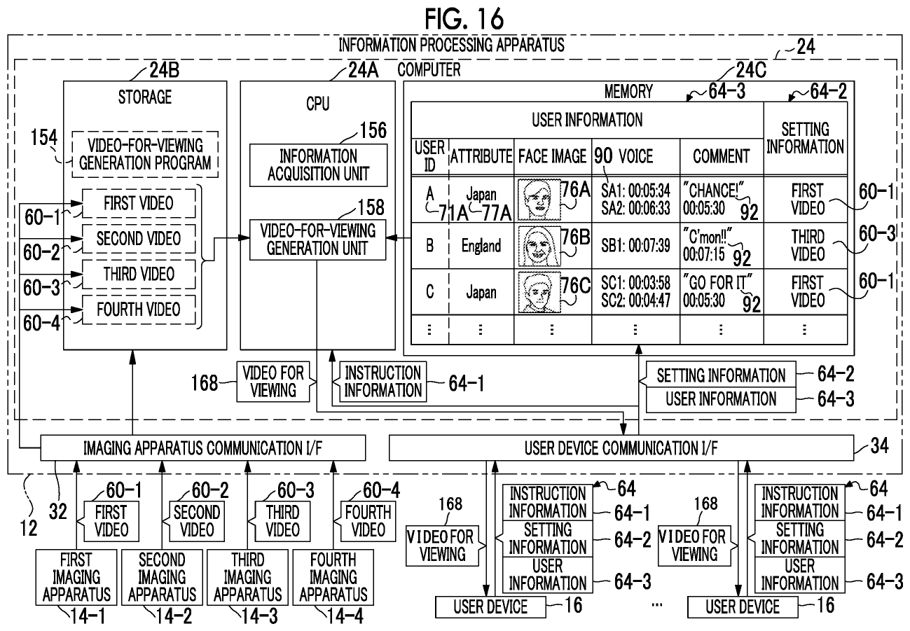

As shown in FIG. 16 as an example, the first imaging apparatus 14-1 transmits a video acquired by performing imaging to the information processing apparatus 12 as a first video 60-1. The second imaging apparatus 14-2 transmits a video acquired by performing imaging to the information processing apparatus 12 as a second video 60-2. The third imaging apparatus 14-3 transmits a video acquired by performing imaging to the information processing apparatus 12 as a third video 60-3. The fourth imaging apparatus 14-4 transmits a video acquired by performing imaging to the information processing apparatus 12 as a fourth video 60-4. The first to fourth videos 60-1 to 60-4 are stored in the storage 24B via the imaging apparatus communication I/F 32. It should be noted that the first to fourth videos 60-1 to 60-4 are examples of a “plurality of videos” according to the technology of the present disclosure.

The CPU 24A of the information processing apparatus 12 is operated as an information acquisition unit 156 and a video-for-viewing generation unit 158 in accordance with a video-for-viewing generation program 154 to execute the video-for-viewing generation processing.

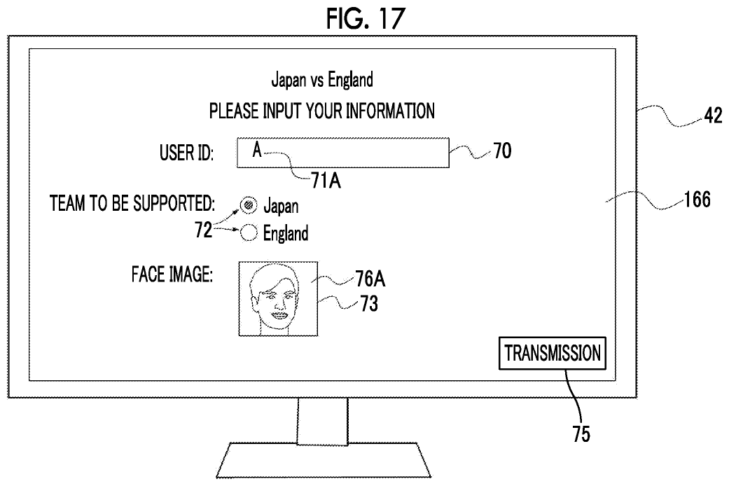

In the video-for-viewing generation processing according to the second embodiment, in a case in which the instruction information 64-1 transmitted from at least one of the plurality of user devices 16 is received, the information acquisition unit 156 generates an information acquisition screen 166 shown in FIG. 17 as an example. The information acquisition unit 56 transmits the generated information acquisition screen 166 to the user device 16 which is the output source of the instruction information 64-1.

The user device 16 receives the information acquisition screen 166, and displays the received information acquisition screen 166 on the display 42. FIG. 17 shows the information acquisition screen 166 displayed on the display 42 of the user device 16 of the user A. The information acquisition screen 166 is different from the information acquisition screen 66 according to the first embodiment in that the selection button 74 for selecting the player of interest is not provided.

After inputting the information to the information acquisition screen 166, the user A clicks the transmission button 75 with the mouse 40A. As a result, the information input to the information acquisition screen 166 is transmitted to the information processing apparatus 12 from the user device 16 as the user information 64-3. The information acquisition unit 56 receives the user information 64-3 transmitted from the user device 16, and stores the received user information 64-3 in the memory 24C.

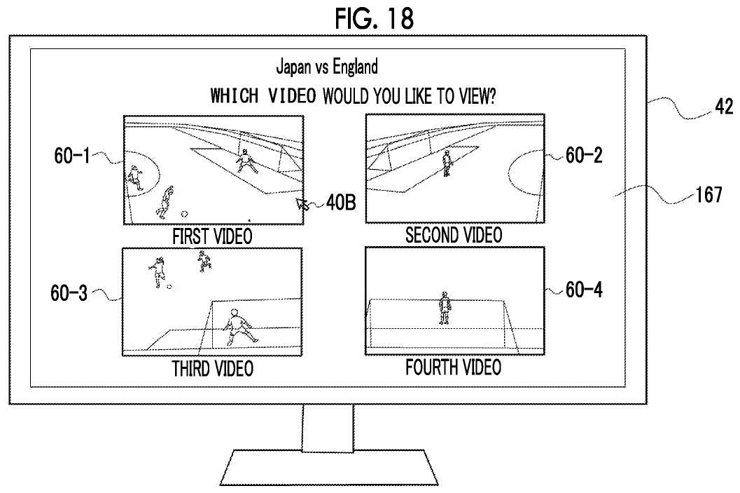

Next, the information acquisition unit 156 generates a video selection screen 167 shown in FIG. 18 as an example. The information acquisition unit 156 transmits the generated video selection screen 167 to the user device 16 which is the output source of the user information 64-3.

The user device 16 receives the video selection screen 167, and displays the received video selection screen 167 on the display 42. The video selection screen 167 displays the first to fourth videos 60-1 to 60-4 acquired by imaging with the first to fourth imaging apparatuses 14-1 to 14-4.

The user selects any one of the first to fourth videos 60-1 to 60-4 on the video selection screen 167 by using a pointer 40B of the mouse 40A as the video to be viewed. For example, in FIG. 18, the first video 60-1 is selected. As a result, video selection information indicating the first video 60-1 is transmitted to the information processing apparatus 12 from the user device 16. The information acquisition unit 56 receives the video selection information transmitted from the user device 16 and stores the received video selection information in the memory 24C as the setting information 64-2 of the user A. It should be noted that the video selection information is an example of “information related to which of a plurality of videos is to be viewed” according to the technology of the present disclosure.

The video-for-viewing generation unit 158 generates the video for viewing 168 by superimposing the user information 64-3 related to the user of which the same setting information 64-2 is the same on the video selected as the video to be viewed.

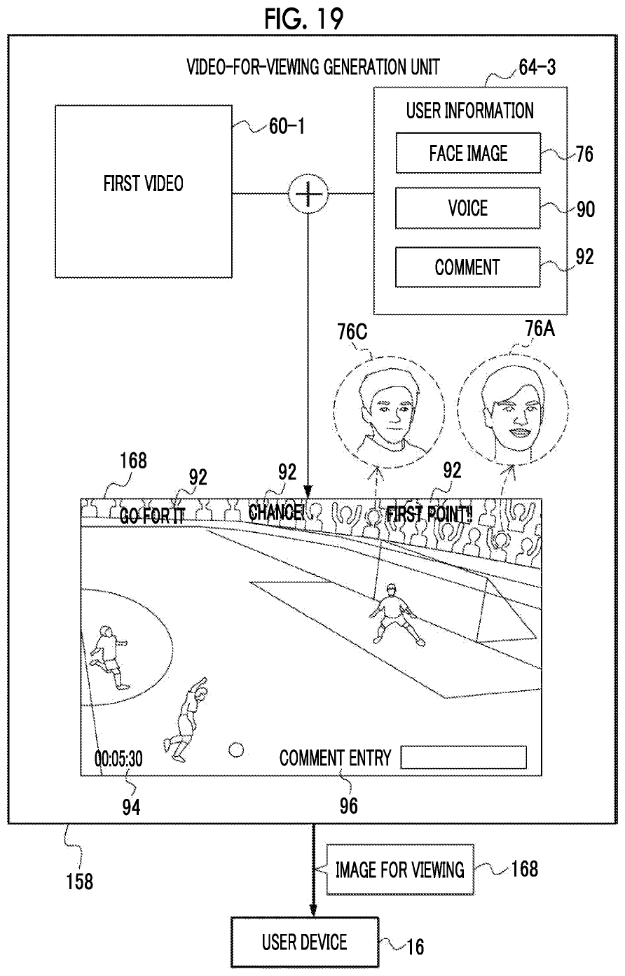

As shown in FIG. 19 as an example, in a case in which the request information 64 is received from the user A, the video-for-viewing generation unit 158 acquires the first video 60-1 corresponding to the setting information 64-2 of the user A from the storage 24B. In addition, the video-for-viewing generation unit 158 acquires the user information 64-3 related to the user (user C or the like) who sets the same setting information 64-2 as the user A from the memory 24C. The video-for-viewing generation unit 158 generates the video for viewing 168 by superimposing the user information 64-3 acquired from the memory 24C on the first video 60-1 acquired from the storage 24B. The video-for-viewing generation unit 158 transmits the generated video for viewing 168 to the user device 16 of the user A.

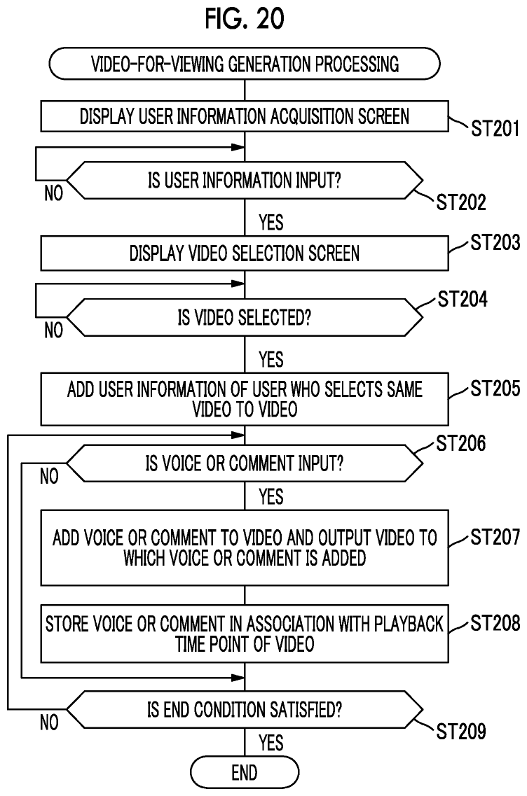

Next, an action of the information processing apparatus 12 according to the second embodiment will be described with reference to FIG. 20. The video-for-viewing generation processing shown in FIG. 20 is realized by the CPU 24A executing the video-for-viewing generation program 154. In addition, the video-for-viewing generation processing shown in FIG. 20 is started in a case in which the CPU 24A receives the instruction information 64-1 from at least one of the plurality of user devices 16.

In the video-for-viewing generation processing shown in FIG. 20, first, in step ST201, the information acquisition unit 156 generates the information acquisition screen 166, and transmits the generated information acquisition screen 166 to the user device 16 which is the output source of the instruction information 64-1. The user device 16 receives the information acquisition screen 166, and displays the received information acquisition screen 166 on the display 42. Thereafter, the video-for-viewing generation processing proceeds to step ST202.

In step ST202, the information acquisition unit 156 determines whether or not the user information 64-3 requested on the information acquisition screen 166 is input. In step ST202, in a case in which the user information 64-3 is input, a positive determination is made, and the video-for-viewing generation processing proceeds to step ST203. In step ST202, in a case in which the user information 64-3 is not input, a negative determination is made, and the video-for-viewing generation processing proceeds to step ST202.

In step ST203, the information acquisition unit 156 generates the video selection screen 167, and transmits the generated video selection screen 167 to the user device 16 which is the output source of the instruction information 64-1. The user device 16 receives the video selection screen 167, and displays the received video selection screen 167 on the display 42. Thereafter, the video-for-viewing generation processing proceeds to step ST204.

In step ST204, the information acquisition unit 156 determines whether or not the video to be viewed is selected on the video selection screen 167. In step ST204, in a case in which the video to be viewed is selected, a positive determination is made, and the video-for-viewing generation processing proceeds to step ST205. In step ST204, in a case in which the video to be viewed is not selected, a negative determination is made, and the video-for-viewing generation processing proceeds to step ST204.

In step ST205, the video-for-viewing generation unit 158 adds the user information 64-3 of the user who is the output source of the instruction information 64-1 and the user information 64-3 of the user having the same setting information 64-2 as the user who is the output source of the instruction information 64-1 to the selected video, and transmits the video to which the user information 64-3 is added, to the user device 16 of the user who is the output source of the instruction information 64-1 as the video for viewing 168. Thereafter, the video-for-viewing generation processing proceeds to step ST206.

Since step ST206 to step ST209 are the same as ST108 to ST111 of the video-for-viewing generation processing shown in FIG. 10, the description thereof will be omitted.

As described above, in the second embodiment, the setting information 64-2 is the information related to which of the first to fourth videos 60-1 to 60-4 obtained by imaging with the first to fourth imaging apparatuses 14-1 to 14-4 is viewed. Therefore, with the present configuration, it is possible to easily generate sympathy among the users who view the video for viewing 168, as compared with a case in which the user is made to view an unprocessed video as it is.

In addition, in the second embodiment, the video-for-viewing generation unit 158 generates the video for viewing 168 by superimposing the user information 64-3 related to the user of which the setting information 64-2 is the same on the video to be viewed. Therefore, with the present configuration, it is possible to enhance the realistic effect of the video for viewing 168 as compared with a case in which the user information 64-3 related to the user of which the setting information 64-2 is the same is not superimposed on the video to be viewed.

In the second embodiment, the number of imaging apparatuses provided in the soccer stadium 18 is four, but the technology of the present disclosure is not limited to this, and the number of imaging apparatuses may be more than or less than four. In a case in which the number of imaging apparatuses is large, it is considered that the imaging apparatuses in which the distance between the imaging apparatuses is within the predetermined range acquire similar videos. Therefore, the video-for-viewing generation unit 158 may generate the video for viewing 168 by superimposing the user information 64-3 of the user who designates the videos obtained by the imaging apparatuses of which the distance between the imaging apparatuses is within the predetermined range as the setting information 64-2 on the video to be viewed. In addition, the video-for-viewing generation unit 158 may generate the video for viewing 168 by using the user information 64-3 of the user who designates the video obtained by imaging similar regions in the soccer stadium 18 as the setting information 64-2, regardless of the distance between the imaging apparatuses. It should be noted that the predetermined range is, for example, a value derived as the distance between the imaging apparatuses from which similar videos are acquired by a test using an actual machine and/or a computer simulation. The predetermined range is an example of a “predetermined range” according to the technology of the present disclosure.

### Third Embodiment

In the third embodiment, the setting information 64-2 includes information related to which of a first edited video 160-1 and a second edited video 160-2 created based on the first to fourth videos 60-1 to 60-4 is to be viewed. In the following, a difference from the second embodiment will be described. In the following description, the same configurations as those of the second embodiment will be represented by the same reference numerals as those of the second embodiment, and the same configurations and actions as those of the second embodiment will be omitted.

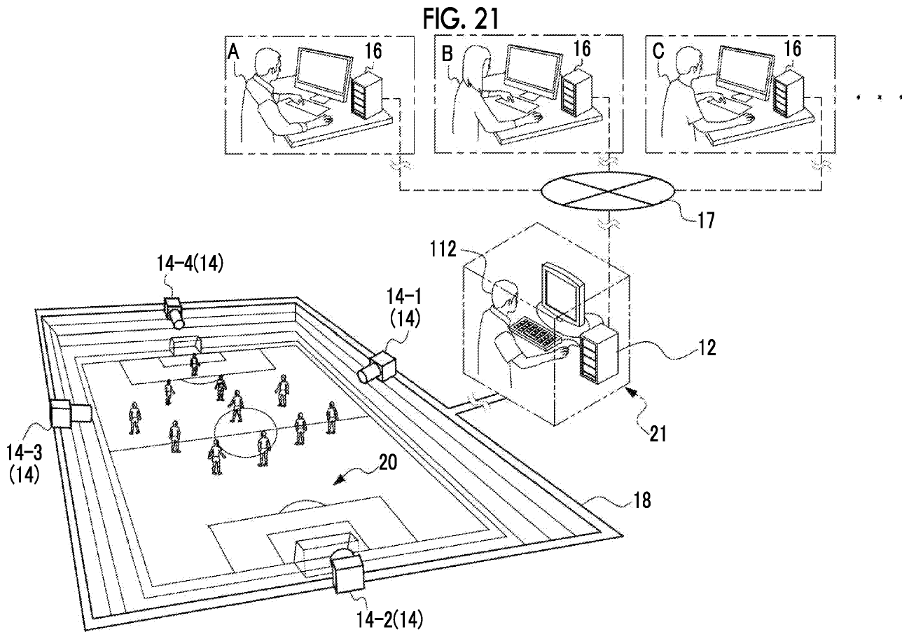

As shown in FIG. 21 as an example, in the control room 21, there is an editor 112 who creates the first edited video 160-1 and the second edited video 160-2. The editor 112 creates the first and second edited videos 160-1 and 160-2 based on the first to fourth videos 60-1 to 60-4 by using the computer 24 provided in the information processing apparatus 12. The first edited video 160-1 is, for example, a video for a fan of the Japan team, which includes a content specialized for the Japan team. Support and/or commentary specialized for the Japan team may be added to the first edited video 160-1 as the audible data or the visible data. On the other hand, the second edited video 160-2 is a video for a fan of the England team, which includes a content specialized for the England team. Support and/or commentary specialized for the England team may be added to the second edited video 160-2 as the audible data or the visible data. The editor 112 stores the created first and second edited videos 160-1 and 160-2 in the storage 24B. It should be noted that the first and second edited videos 160-1 and 160-2 are examples of a “plurality of edited videos” according to the technology of the present disclosure.

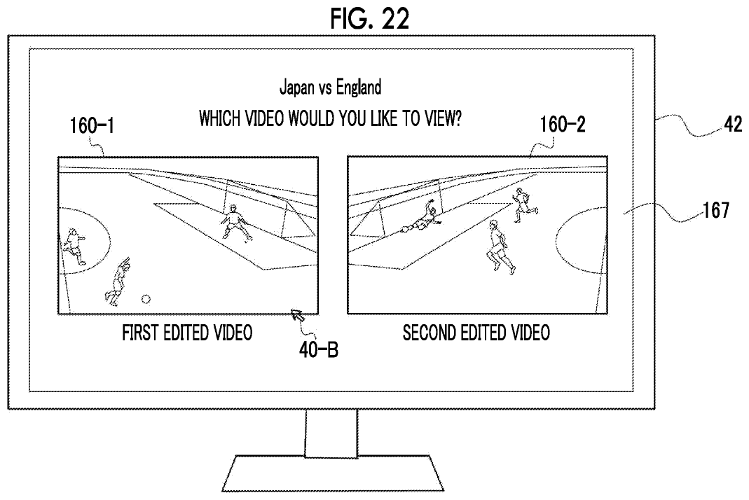

As an example, as shown in FIG. 22, the first edited video 160-1 and the second edited video 160-2 are displayed on the video selection screen 167. The user selects any one of the first edited video 160-1 or the second edited video 160-2 on the video selection screen 167 by using the pointer 40B of the mouse 40A as the video to be viewed. For example, FIG. 22 shows the video selection screen 167 displayed on the user device 16 of the user A, in which the first edited video 160-1 is selected.

The video-for-viewing generation unit 158 generates the video for viewing 168 by superimposing the user information 64-3 related to the user of which the same setting information 64-2 is the same on the edited video selected as the video to be viewed.

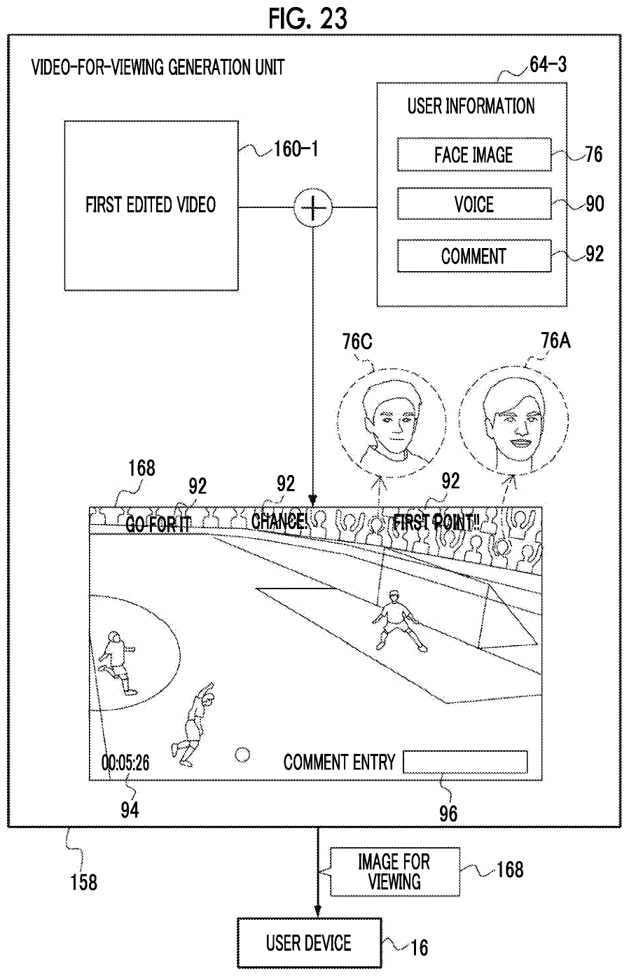

As shown in FIG. 23 as an example, in a case in which the request information 64 is received from the user A, the video-for-viewing generation unit 158 acquires the first edited video 160-1 corresponding to the setting information 64-2 of the user A from the storage 24B. In addition, the video-for-viewing generation unit 158 acquires the user information 64-3 related to the user (user C or the like) who sets the same setting information 64-2 as the user A from the memory 24C. The video-for-viewing generation unit 158 generates the video for viewing 168 by superimposing the user information 64-3 acquired from the memory 24C on the first edited video 160-1 acquired from the storage 24B. The video-for-viewing generation unit 158 transmits the generated video for viewing 168 to the user device 16 of the user A.

As described above, in the third embodiment, the setting information 64-2 includes the information related to which of the first edited video 160-1 and the second edited video 160-2 created based on the first to fourth videos 60-1 to 60-4 is to be viewed, which are obtained by imaging with the first to fourth imaging apparatuses 14-1 to 14-4. Therefore, with the present configuration, it is possible to easily generate sympathy among the users who view the edited video, as compared with a case in which the user is made to view an unprocessed edited video as it is.

In addition, in the third embodiment, the video-for-viewing generation unit 158 generates the video for viewing 168 by superimposing the user information 64-3 related to the user of which the setting information 64-2 is the same on the edited video to be viewed. Therefore, with the present configuration, it is possible to enhance the realistic effect of the video for viewing 168 as compared with a case in which the user information 64-3 related to the user of which the setting information 64-2 is the same is not superimposed on the edited video to be viewed.

In the third embodiment, the number of edited videos is two, but the technology of the present disclosure is not limited to this, and the number of edited videos may be equal to or more than three. In this case, in a case in which there are similar edited videos among the plurality of edited videos, the video-for-viewing generation unit 158 may generate the video for viewing 168 by superimposing the user information 64-3 of the user who designates the similar edited videos as the setting information 64-2 on the edited video to be viewed. In other words, the video-for-viewing generation unit 158 may generate the video for viewing 168 by superimposing the user information 64-3 related to the user of which the setting information 64-2 is within the predetermined range on the edited video to be viewed. In this case, the predetermined range is a range in which a degree of similarity between the edited videos is decided to be equal to or higher than a threshold value. The predetermined range is an example of a “predetermined range” according to the technology of the present disclosure.

It should be noted that, in the embodiments described above, the face image 76 acquired by the camera 48 is described as an example of the image for visually specifying the user of which the setting information 64-2 is within the predetermined range, but the technology of the present disclosure is not limited to this. The image for visually specifying the user of which the setting information 64-2 is within the predetermined range may be an image acquired by an imaging apparatus other than the camera 48, and may be an avatar image, an illustration image, or an image other than the face of the user as long as the image is the image for specifying the user.

In addition, in the embodiments described above, the user information 64-3 is acquired via the information acquisition screen 66 or 166, but the technology of the present disclosure is not limited to this, and the user information 64-3 may be registered in the information processing apparatus 12 by the user in advance before the instruction information 64-1 is output. In addition, the user information 64-3 does not have to be acquired, and only the setting information 64-2 may be acquired. In this case, instead of the display of the user information 64-3 in a superimposed manner, the number of users of which the setting information 64-2 is the same or the predetermined range may be displayed together with the image for viewing 68, the video for viewing 168, the first edited video 160-1, or the second edited video 160-2. In this case, the number of users of which the setting information 64-2 is the same or within the predetermined range is an example of “viewer information” according to the technology of the present disclosure. In addition, for example, an object, such as a spectator, may be added and displayed in a superimposed manner in accordance with the number of users of which the setting information 64-2 is the same or within the predetermined range.

In addition, in addition, in the embodiments described above, the soccer stadium 18 is described as an example, but it is merely an example, and any place, such as a baseball stadium, a rugby stadium, a curling stadium, an athletics stadium, a swimming pool, a concert hall, an outdoor music hall, and a theater venue, may be adopted as long as a plurality of physical cameras can be installed.

In addition, in the embodiments described above, the computer 24 is described as an example, but the technology of the present disclosure is not limited to this. For example, instead of the computer 24, a device including an ASIC, an FPGA, and/or a PLD may be applied. In addition, instead of the computer 24, a combination of a hardware configuration and a software configuration may be used.

In addition, in the embodiments described above, the form example is described in which the information processing is executed by the CPU 24A of the information processing apparatus 12, but the technology of the present disclosure is not limited to this. Instead of the CPU 24A, a GPU may be adopted or a plurality of CPUs may be adopted. In addition, various processing may be executed by one processor or a plurality of processors which are physically separated.

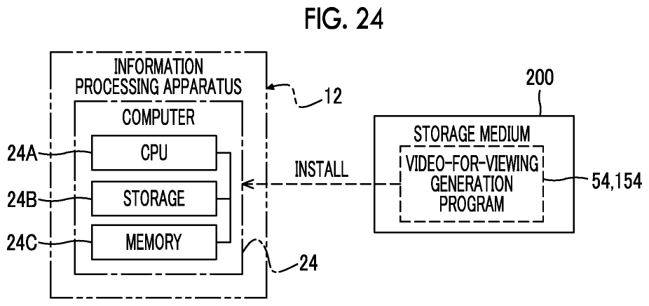

In addition, in the embodiments described above, the video-for-viewing generation program 54 or the video-for-viewing generation program 154 is stored in the storage 24B, but the technology of the present disclosure is not limited to this, and the video-for-viewing generation program 54 or 154 may be stored in any portable storage medium 200 as shown in FIG. 24 as an example. The storage medium 200 is a non-transitory storage medium. Examples of the storage medium 200 include an SSD or a USB memory. The video-for-viewing generation program 54 or 154 stored in the storage medium 200 is installed in the computer 24, and the CPU 24A executes the video-for-viewing generation processing in accordance with the video-for-viewing generation program 54 or 154.

In addition, the video-for-viewing generation program 54 or 154 may be stored in a program memory of another computer or server device connected to the computer 24 via a communication network (not shown), and the video-for-viewing generation program 54 or 154 may be downloaded to the information processing apparatus 12 in response to the request of the information processing apparatus 12. In this case, the information processing based on the downloaded video-for-viewing generation program 54 or 154 is executed by the CPU 24A of the computer 24.

The following various processors can be used as a hardware resource for executing the information processing. As described above, examples of the processor include a CPU, which is a general-purpose processor that functions as the hardware resource for executing the information processing in accordance with software, that is, the program.

In addition, another example of the processor includes a dedicated electric circuit which is a processor having a circuit configuration specially designed for executing specific processing, such as an FPGA, a PLD, or an ASIC. The memory is incorporated in or connected to any processor, and any processor executes the information processing by using the memory.

The hardware resource for executing the information processing may be configured by one of these various processors, or may be configured by a combination (for example, a combination of a plurality of FPGAs or a combination of a CPU and an FPGA) of two or more processors of the same type or different types. In addition, the hardware resource for executing the information processing may be one processor.

As an example in which the hardware resource is configured by one processor, first, there is a form in which one processor is configured by a combination of one or more CPUs and software, and the processor functions as the hardware resource for executing the information processing, as represented by a computer, such as a client and a server. Secondly, as represented by SoC, there is a form in which a processor that realizes the functions of the entire system including a plurality of hardware resources for executing the information processing with one IC chip is used. As described above, the information processing is realized by using one or more of the various processors as the hardware resources.

Further, as the hardware structures of these various processors, more specifically, it is possible to use an electric circuit in which circuit elements, such as semiconductor elements, are combined.

In addition, the information processing described above is merely an example. Therefore, it is needless to say that the deletion of an unneeded step, the addition of a new step, and the change of a processing order may be employed within a range not departing from the gist.

The described contents and the shown contents above are the detailed description of the parts according to the technology of the present disclosure, and are merely examples of the technology of the present disclosure. For example, the description of the configuration, the function, the action, and the effect above are the description of examples of the configuration, the function, the action, and the effect of the parts according to the technology of the present disclosure. Accordingly, it is needless to say that unnecessary parts may be deleted, new elements may be added, or replacements may be made with respect to the described contents and shown contents above within a range that does not deviate from the gist of the technology of the present disclosure. In addition, in order to avoid complications and facilitate understanding of the parts according to the technology of the present disclosure, the description of common technical knowledge or the like, which does not particularly require the description for enabling the implementation of the technology of the present disclosure, is omitted in the described contents and the shown contents above.

In the present specification, “A and/or B” is synonymous with “at least one of A or B”. That is, “A and/or B” means that it may be only A, only B, or a combination of A and B. In addition, in the present specification, in a case in which three or more matters are associated and expressed by “and/or”, the same concept as “A and/or B” is applied.

All documents, patent applications, and technical standards described in the present specification are incorporated into the present specification by reference to the same extent as in a case in which the individual documents, patent applications, and technical standards are specifically and individually stated to be incorporated by reference.

With respect to the embodiment described above, the following supplementary note will be further disclosed.

### Supplementary Note 1

An information processing apparatus comprising a processor, and a memory built in or connected to the processor, in which the information processing apparatus generates an image for viewing to be viewed by a plurality of viewer based on an image obtained by imaging with an imaging apparatus, the processor acquires request information for requesting generation of the image for viewing, and executes generation processing of generating the image for viewing in accordance with the acquired request information, the request information includes setting information indicating setting of the image for viewing and viewer information related to the viewer who views the image for viewing, the request information being information corresponding to each of the plurality of viewers, and the generation processing is processing of generating the image for viewing in which, out of the viewer information, the viewer information of which the setting information is within a predetermined range is reflected in the request information of the plurality of viewers.

What is claimed is:

1. An information processing apparatus comprising:
a processor; and
a memory built in or connected to the processor,
wherein the information processing apparatus generates an image for viewing to be viewed by a viewer based on an image obtained by imaging with an imaging apparatus,
the processor
acquires request information for requesting generation of the image for viewing, and
executes generation processing of generating the image for viewing in accordance with the acquired request information,
the request information includes setting information indicating setting of the image for viewing, and
the generation processing is processing of generating the image for viewing to which viewer information related to the viewer of which the setting information is within a predetermined range is reflected in the request information of a plurality of the viewers.

2. The information processing apparatus according to claim 1,
wherein the image for viewing includes a virtual viewpoint image created based on the image.

3. The information processing apparatus according to claim 2,
wherein the setting information includes gaze position specification information for specifying a gaze position used to generate the virtual viewpoint image in a region indicated by the image.

4. The information processing apparatus according to claim 3,
wherein the gaze position is a position of a specific object included in the region.

5. The information processing apparatus according to claim 3,
wherein the gaze position specification information includes a gaze position path information indicating a path of the gaze position.

6. The information processing apparatus according to claim 2,
wherein the processor generates the image for viewing by superimposing the viewer information related to the viewer of which the setting information is within the predetermined range on the virtual viewpoint image.

7. The information processing apparatus according to claim 1,
wherein the image for viewing includes at least one of audible data related to the viewer of which the setting information is within the predetermined range or visible data related to the viewer of which the setting information is within the predetermined range.

8. The information processing apparatus according to claim 7,
wherein the image for viewing is a video, and
the processor generates the image for viewing to which the viewer information is reflected, by adding at least one of the audible data or the visible data to the image for viewing at a timing set by the viewer at a time of playback of the image for viewing.

9. The information processing apparatus according to claim 1,
wherein the image for viewing includes a viewer specification image for visually specifying the viewer of which the setting information is within the predetermined range.

10. The information processing apparatus according to claim 1,
wherein the processor
stores the viewer information in the memory, and
generates the image for viewing to which the viewer information stored in the memory is reflected.

11. The information processing apparatus according to claim 1,
wherein the viewer information includes an attribute related to a taste of the viewer.

12. The information processing apparatus according to claim 1,
wherein the request information includes the viewer information.

13. The information processing apparatus according to claim 1,
wherein the setting information includes information related to which of a plurality of videos obtained by imaging with a plurality of the imaging apparatuses is to be viewed.

14. The information processing apparatus according to claim 13,
wherein the processor generates a video for viewing by superimposing the viewer information related to the viewer of which the setting information is within the predetermined range on the video to be viewed.

15. The information processing apparatus according to claim 1,
wherein the setting information includes information related to which of a plurality of edited videos created based on a plurality of videos obtained by imaging with a plurality of the imaging apparatuses is viewed.

16. The information processing apparatus according to claim 15,
wherein the processor generates a video for viewing by superimposing the viewer information related to the viewer of which the setting information is within the predetermined range on the edited video to be viewed.

17. An information processing method of generating an image for viewing to be viewed by a viewer based on an image obtained by imaging with an imaging apparatus, the method comprising:
acquiring request information for requesting generation of the image for viewing; and
executing generation processing of generating the image for viewing in accordance with the acquired request information,
wherein the request information includes setting information indicating setting of the image for viewing, and
the generation processing is processing of generating the image for viewing to which viewer information related to the viewer of which the setting information is within a predetermined range is reflected in the request information of a plurality of the viewers.

18. A non-transitory computer-readable storage medium storing a program executable by a computer to perform information processing of generating an image for viewing to be viewed by a viewer based on an image obtained by imaging with an imaging apparatus, the information processing comprising:
acquiring request information for requesting generation of the image for viewing; and
executing generation processing of generating the image for viewing in accordance with the acquired request information,
wherein the request information includes setting information indicating setting of the image for viewing, and
the generation processing is processing of generating the image for viewing to which viewer information related to the viewer of which the setting information is within a predetermined range is reflected in the request information of a plurality of the viewers.
